(19) United States
(12) Patent Application Publication
(10) Pub. No.: US 2008/0193180 A1
(43) Pub. Date: Aug. 14, 2008

(54) MEDIUM DETECTING DEVICE AND METHOD, IMAGE FORMING APPARATUS EMPLOYING THE MEDIUM DETECTING DEVICE, AND IMAGE OUTPUT METHOD OF THE SAME

(75) Inventors: Woo-jung SHIM, Suwon-si (KR); Seock-deock Hong, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/970,713

(22) Filed: Jan. 8, 2008

(30) Foreign Application Priority Data
Feb. 8, 2007 (KR) 2007-13170
Feb. 8, 2007 (KR) 2007-13171

(51) Int. Cl. G03G 15/00

(52) U.S. Cl. 399/395

(57) ABSTRACT

A medium detecting device to detect information corresponding to a printing medium fed through a medium transport path, includes a detecting unit to detect a contour form information of the printing medium; and a discriminating unit to determine a format of the printing medium and feeding information based on the contour form information of the printing medium detected by the detecting unit.

### CROSS-REFERENCE TO RELATED APPLICATIONS

This application claims priority under 35 U.S.C. §119(a) from Korean Patent Application Nos. 10-2007-0013170 and 10-2007-0013171, filed on Feb. 8, 2007, in the Korean Intellectual Property Office, the disclosures of which are incorporated herein by reference in their entireties.

### BACKGROUND OF THE INVENTION

1. Field of the Invention

The present general inventive concept relates to a medium detecting device and method, and an image forming apparatus employing the medium detecting device, and an image output method of the same.

2. Description of the Related Art

A conventional printer uses various types of printing media of different standard formats, and is equipped with at least one printing medium feed unit that loads the printing medium. The printing medium feed unit includes a cassette loading a printing medium of a standard format and a multipurpose tray loading a printing medium of a nonstandard format. Further, the printer draws out the printing medium from the printing medium feed unit that loads an appropriate size of the printing medium for a printing image.

However, if the printing medium has a format different from a set standard format of printing medium, a problem occurs when loading the printing medium in the printing medium feed unit. That is, if the printing medium of size different from the print image, for example, the size of the printing medium smaller than the print image, is loaded and the printing image is printed on the loaded printing medium, some part of the printing image may be missed. This may induce a problem of loss of the printing medium and pollution inside the image forming apparatus due to the missed print image.

Also, when the printing medium is fed, the printing medium may be inclined while the printing medium is transported. Then, a part of the print image may be deviated from the printing medium and will result in the above-mentioned miss of the print image. Also the printed printing medium may become useless since the print image is not properly printed.

In order to solve the above-mentioned problem in feeding the printing medium, various arts of detecting a state of feeding have been introduced. The published examples include a method controlling an image forming timing by detecting a leading edge of the printing medium and a method using a detected width of the printing medium for an image forming operation.

More specifically, the present applicant has disclosed an apparatus and a method of detecting a feeding state of a printing medium through United States Patent Publication No. US 2006/0289813 A1 (published date: Dec. 28, 2006, titled of “PAPER DETECTION APPARATUS AND PRINTING METHOD”). This disclosed invention above generally a feeding of a printing medium, a printing medium size and a printing medium skew, thereby preventing a printing error due to disagreement between the printing medium size and an image size, and the skew of the printing medium.

Further, in an electro-photographic color image forming apparatus, particularly, in a single path electro-photographic color image forming apparatus, a color registration method for compensating various overlapped images has been suggested to solve a problem of inexact overlapping between color images of respective colors when forming a full color image by overlapping the color images of the respective colors. In contrast, a method of a conventional color registration demands a complex arithmetical operation or has a problem of being sensible to an error produced by a noise component in a registration mark.

### SUMMARY OF THE INVENTION

The present general inventive concept provides a medium detecting device and method to precisely detect a format of a printing medium fed from a printing medium feed unit, a feeding position and skewing of the printing medium.

The present general inventive concept also provides an image forming apparatus employing a medium detecting device to precisely detect a format of a printing medium fed from a printing medium feed unit, a feeding position and skewing of the printing media.

The present general inventive concept also provides an image output method based on information acquired through the medium detecting device about a fed printing medium to optimally output while transferring a developed image on a photosensitive body to a printing medium.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a medium detecting device that detects information on a printing medium fed through a medium transport path, including a detecting unit to detect contour form information of the printing medium, and a discriminating unit to determine a format of the printing medium and feeding information based on the contour form information of the printing medium detected by the detecting unit.

The feeding information may include at least one of a magnification, a skew quantity and a shift quantity of the printing medium.

The detecting unit may include a light source to radiate a light, and a plurality of light receiving elements arranged larger than a maximum permitted width of the printing medium across in a width direction of printing medium, wherein the detecting unit detects a size, a skew quantity and the shift quantity of the fed printing medium by selectively receiving the light radiated from the light source depending on an interference of the printing medium.

The plurality of light receiving elements may have equal sizes and may be separated from each other by a constant interval.

The detecting unit may include a plurality of sensing bars installed on the medium transport path in the width direction of the printing medium to be freely rotated, and a plurality of sensors to sense respective rotation states of the sensing bars depending on an interference of the printing medium, wherein the detecting unit detects a size, a skew quantity and a shift quantity of the fed printing medium by selectively receiving the light radiated from the light source depending on an interference of the printing medium.

Each of the plurality of sensors may include a light emitting element to radiate a light, and a light receiving element to face the light emitting element leaving each sensing bar of the plurality of sensing bars therebetween and to selectively receive the light radiated from the light emitting element depending on a position of the sensing bar.

The discriminating unit may include a memory to store information on the format of the printing medium, and a counter to calculate a transport time between a leading and trailing edges of the printing medium wherein the medium detecting device determines the format of the fed printing medium by comparing information on the printing medium detected by the detecting unit and the counter and the information on the format of the printing medium stored in the memory.

The detecting unit may include a first detecting unit disposed at a first location on the medium transport path along a width direction of the printing medium, and a second detecting unit disposed at a second location on the medium transport path along the width direction of the printing medium distanced from the first detecting unit.

The discriminating unit may determine a format and a feeding position of the printing medium based on data detected in the first and the second detecting units.

The discriminating unit may include a memory to store information on the format of the printing medium, and a counter to calculate a transport time between a leading and trailing edges of the printing medium, wherein the discriminating unit determines the format of the fed printing medium by comparing information on the printing medium detected by the first detecting unit, the second detecting unit and the counter and the information on the format of the printing medium stored in the memory.

The foregoing and/or other aspects and utilities of the present general inventive concept can also be achieved by providing a medium detecting method of detecting information on a fed printing medium through a medium transport path, the method including detecting the contour form information of the fed printing medium, and discriminating a format and feeding information on the fed printing medium based on the detected contour form information of the fed printing medium.

The feeding information may include at least one of a magnification, a skew quantity and a shift quantity of the fed printing medium.

The detecting of the contour form information of the fed printing medium may include radiating a light, outputting a signal after receiving the radiated light through a plurality of light receiving elements arranged longer than a maximum permitted width of the printing medium across in a width direction of the fed printing medium in every predetermined time interval dependent on an existence of the fed printing medium, and recognizing the contour form information of the fed printing medium using the output signal.

The discriminating may include determining the format of the fed printing medium, determining the skew quantity of the fed printing medium, and determining the shift quantity of the fed printing medium.

The determining the format of the fed printing medium may include calculating a width of the fed printing medium with the output signal from the detecting of the fed printing medium contour form information, and calculating a length of the fed printing medium by an arithmetic operation with a pass time of the fed printing medium at a location of the detecting unit.

The determining the format of the fed printing medium may further include storing a standard format of a printing medium, and deciding a format of the fed printing medium format through comparing the stored standard format with the calculated width and length of the fed printing medium.

The determining the format of the fed printing medium may include determining a feeding direction of the fed printing medium, calculating a width of the fed printing medium with the output signal from the detecting of the contour form information of the fed printing medium, storing a standard format of a printing medium, and deciding a format of the fed printing medium format including a length of the fed printing medium through comparing the standard format of the printing medium with the calculated width of the fed printing medium based on the determining of the feeding direction of the fed printing medium.

The calculating the width of the fed printing medium with the output signal may satisfy a following equation: P_{width}=sqrt(X²+Y²X)=(i_cw−i_{ccw})×(w+d)+m Y=f×V×T where i_cw is an index value of the light receiving element disposed at a location which first meets a corner vertex of the fed printing medium and i_ccw is an index value of the light receiving element disposed at a location which meets an opposite other corner vertex of the fed printing medium, w is the width of the light receiving element, d is the interval between the light receiving elements, m is a margin that compensates to consider when the edge of the fed printing medium covers one light receiving element or the interval, f is a number of counts counted during an entering of the printing medium from the first entering of the corner vertex of the fed printing medium till the last entering of the other corner vertex of the fed printing medium, V is a feeding speed of the fed printing medium, and T is a detecting period of the light receiving element.

The plurality of light receiving elements may be separated from their adjacent light receiving elements by a predetermined interval and the determining the format of the fed printing medium includes deciding a corner vertex position of a leading edge of the fed printing medium when the corner vertex of the fed printing medium enters the interval between the adjacent light receiving elements.

The deciding the corner vertex position may include storing an output pattern transition of the light receiving elements in a lookup table according to the skew quantity, storing sensing values detected in the light receiving elements in a periodic time interval, deciding the skew quantity by comparing the sensing values detected by the light receiving elements with the pattern stored in the lookup table, calculating a first line extended straight from the leading edge of the printing medium and a second line extended straight from one side edge of the printing medium, and calculating the corner vertex position of the leading edge of the fed printing medium from an intersection point of the first line and the second line.

The determining the skew quantity of the fed printing medium may include storing a number of counts from a time when the fed printing medium is first detected until two opposite side edges of the fed printing medium are detected, deciding whether the fed printing medium is skewed according to which light receiving element among the plurality of light receiving elements first detects the fed printing medium, storing an index value of the light receiving element disposed at a location which first meets a corner vertex of the fed printing medium and an index value of the light receiving element disposed at a location which meets an opposite other corner vertex of the fed printing medium, and calculating the skew quantity through comparing the number of counts and the stored index values stored.

The skew quantity may satisfy a following equation: Skew quantity=arctan(Y/X)X=(i_cw−i_ccw)×(w+d)+m Y=f×V×T where i_cw is an index value of the light receiving element disposed at a location which first meets a corner vertex of the fed printing medium and i_ccw is an index value of the light receiving element disposed at a location which meets an opposite other corner vertex of the fed printing medium, w is the width of the light receiving element, d is the interval between the light receiving elements, m is a margin that compensates to consider when the edge of the fed printing medium covers one light receiving element or the interval, f is a number of counts counted during an entering of the printing medium from the first entering of the corner vertex of the fed printing medium till the last entering of the other corner vertex of the fed printing medium, V is a feeding speed of the fed printing medium, and T is a detecting period of the light receiving element.

The determining the skew quantity of the fed printing medium may further include discerning whether the skew quantity is changed while transporting the fed printing medium, and calculating the skew quantity at a predetermined target location if the skew quantity changes.

The discerning of the skew quantity change may include calculating the respective skew quantities of the fed printing medium through a first detecting unit and a second detecting unit which respectively have a plurality of light receiving elements arranged in the width direction of the fed printing medium at a first location and a second location of the medium transport path, and deciding whether the skew quantity is changed by comparing the skew quantities detected in the first and second detecting units.

The skew quantity at the target location may be calculated by using a following equation: Δθ₂=Δθ₁×(1+d₂/d₁) where Δθ₂ is a difference of the skew quantity at the target location from the first location, Δθ₁ is a difference of skew quantity at the second location from the skew quantity at the second location, d₁ is the distance from the first location to the second location, and d₂ is the distance from the second location to the target location.

The determining the shift quantity of the fed printing medium may include deciding which light receiving elements among the plurality of the light receiving element located at left and right parts of leading edge of the fed printing medium detect the fed printing medium, storing the output values from the corresponding light receiving elements respectively located at the left and right top boundary of the fed printing medium in a first index (i_cw) and (i_ccw), and calculating the shift quantity of the printing medium at a location of the light receiving elements through comparing the stored values in the first index and the second index.

The shift quantity may satisfy a following equation: shift quantity=[(i_cw+i_ccw)/2−i_cnt]×(w+d)+m where w is the width of each light receiving element, d is an interval between each light receiving element, m is a margin and i_cnt is an index value at a center. If the shift quantity from equation (4) is negative, the printing medium is shifted to left side, and if the shift quantity from equation (4) is positive, the printing medium is shifted to right side.

The determining the shift quantity of the fed printing medium may further include discerning whether the shift quantity is changed while transporting the printing medium, and calculating the shift quantity at a predetermined target location if the shift quantity changes.

The discerning of the shift quantity change may include calculating the respective shift quantities of the fed printing medium through a first detecting unit and a second detecting unit arranged in the width direction of the fed printing medium at a first location and a second location of the medium transport path, and deciding whether the shift quantity is changed by comparing the shift quantities detected in the first and second detecting units.

The shift quantity at the target location may be calculated by using a following equation: ΔS₂=ΔS₁×(1+d₂/d₁) where ΔS₂ is a difference of the shift quantity at the target location from the shift quantity at the first location, ΔS₁ is a difference of the shift quantity at the second location from the shift quantity at the first location, d₁ is the distance from the first location to the second location, and d₂ is the distance from the second location to the target location.

The foregoing and/or other aspects and utilities of the present general inventive concept can also be achieved by providing an image forming apparatus including a medium feed unit to feed a loaded printing medium through a medium transport path, an image forming unit to form an image on the fed printing medium, a detecting unit to detect contour form information of the printing medium, and a medium detecting device equipped with a discriminating unit to determine a format of the printing medium and feeding information based on the contour form information of the printing medium detected by the detecting unit.

The feeding information may include at least one of a magnification, a skew quantity and a shift quantity of the printing medium.

The detecting unit may include a light source to radiate a light, and a plurality of light receiving elements arranged larger than a maximum permitted width of the printing medium across in a width direction of printing medium, wherein the detecting unit detects a size, a skew quantity and a shift quantity of the fed printing medium by selectively receiving the light radiated from the light source depending on an interference of the printing medium.

The plurality of light receiving elements may have equal sizes and may be separated from each other by a constant interval.

The detecting unit may include a plurality of sensing bars installed on the medium transport path in the width direction of the printing medium to be freely rotated, and a plurality of sensors to sense respective rotation states of the sensing bars depending on an interference of the printing medium, wherein the detecting unit detects a size, a skew quantity and a shift quantity of the fed printing medium by selectively receiving the light radiated from the light source depending on an interference of the printing medium.

Each sensor of the plurality of sensors may include a light emitting element to radiate a light, and a light receiving element to face the light emitting element leaving each sensing bar of the plurality of sensing bars therebetween and to selectively receive the light radiated from the light emitting element depending on a position of the sensing bar.

The discriminating unit may include a memory to store information on the format of the printing medium, and a counter to calculate a transport time between a leading and trailing edges of the printing medium, and the discriminating unit may determine the format of the fed printing medium through comparing information on the printing medium detected by the detecting unit and the counter and the information on the format of the printing medium stored in the memory.

The detecting unit may include a first detecting unit disposed at a first location on the medium transport path along the width direction of the printing medium, and a second detecting unit disposed at a second location on the medium transport path along the width direction of the printing medium distanced from the first detecting unit.

The discriminating unit may determine the format and a feeding position of the printing medium based on data detected in the first and the second detecting units.

The discriminating unit may include a memory to store information on the format of the printing medium, and a counter to calculate a transport time between a leading and trailing edges of the printing medium, and may determine the format of the fed printing medium by comparing information on the printing medium detected by the first detecting unit, the second detecting unit and the counter and the information on the format of the printing medium stored in the memory.

The image forming unit may form the image on the printing medium fed by an electro-photographic process or an ink-jet head process.

The image forming apparatus may further include an image compensating unit to compensate an image forming error through feedback of the contour form information of the fed printing medium detected by the media detecting device.

The image forming apparatus may further include a user interface unit to inform a user whether the format of the fed printing medium corresponds with a medium format set by a user.

The foregoing and/or other aspects an utilities of the present inventive concept can also be achieved by providing an image output method of an image forming apparatus including a medium feed unit to feed a loaded printing medium through a medium transport path, an image forming unit to form an image on the fed printing medium, and a medium detecting device which is provided on a medium transport path and detects information of the fed printing medium, the image output method including detecting the contour form information of the fed printing medium, discriminating a format and feeding information on the fed printing medium based on the detected contour form information of the fed printing medium, and compensating an image forming error through feedback of the detected format and a feeding position of the fed printing medium

The feeding information may include at least one of a magnification, a skew quantity and a shift quantity of the fed printing medium.

The detecting of the contour form information of the fed printing medium may include radiating a light, outputting a signal after receiving the radiated light through a plurality of light receiving elements which are arranged longer than a maximum permitted width of the printing medium across in a width direction of the fed printing medium in every predetermined time interval dependent on an existence of the fed printing medium, and recognizing the contour form information of the fed printing medium using the output signal.

The discriminating may include determining the format of the fed printing medium, determining the skew quantity of the fed printing medium, and determining the shift quantity of the fed printing medium.

The determining the format of the fed printing medium may include calculating a width of the fed printing medium with the output signal from the detecting of the fed printing medium contour form information, and calculating a length of the fed printing medium by an arithmetic operation with a pass time of the fed printing medium at a location of the detecting unit.

The determining the format of the fed printing medium may further include storing a standard format of a printing medium, and deciding a format of the fed printing medium format by comparing the stored standard format with the calculated width and length of the fed printing medium.

The determining the format of the fed printing medium may include determining a feeding direction of the fed printing medium, calculating a width of the fed printing medium with the output signal from the detecting of the contour form information of the fed printing medium, storing a standard format of a printing medium, and deciding a format of the fed printing medium format including a length of the fed printing medium through comparing the standard format of the printing medium with the calculated width of the fed printing medium based on the determining of the feeding direction of the fed printing medium.

The calculating the width of the fed printing medium with the output signal may satisfy a following equation: P_{width}=sqrt(X²+Y²X)=(i_cw−i_ccw)×(w+d)+m Y=f×V×T where i_cw is an index value of the light receiving element disposed at a location which first meets a corner vertex of the fed printing medium and i_ccw is an index value of the light receiving element disposed at a location which meets an opposite other corner vertex of the fed printing medium, w is the width of the light receiving element, d is the interval between the light receiving elements, m is a margin that compensates to consider when the edge of the fed printing medium covers one light receiving element or the interval, f is a number of counts counted during an entering of the printing medium from the first entering of the corner vertex of the fed printing medium till the last entering of the other corner vertex of fed printing medium, V is a feeding speed of the fed printing medium, and T is a detecting period of the light receiving element.

The plurality of light receiving elements may be separated from their adjacent light receiving elements by a predetermined interval, and the determining the format of the fed printing medium may include deciding a corner vertex position of a leading edge of the fed printing medium when the corner vertex of the fed printing medium enters the interval between the adjacent light receiving elements.

The deciding the corner vertex position may include storing an output pattern transition of the light receiving elements in a lookup table according to the skew quantity, storing sensing values detected in the light receiving elements in a periodic time interval, deciding the skew quantity by comparing the sensing values detected by the light receiving elements with the pattern stored in the lookup table, calculating a first line extended straight from the leading edge of the printing medium and a second line extended straight from one side edge of the printing medium, and calculating the corner vertex position of the leading edge of the fed printing medium from an intersection point of the first line and the second line.

The determining the skew quantity of the fed printing medium may include storing a number of counts from a time when the fed printing medium is first detected until two opposite side edges of the fed printing medium are detected, deciding whether the fed printing medium is skewed according to which light receiving element among the plurality of light receiving elements first detects the fed printing medium, storing an index value of the light receiving element disposed at a location which first meets a corner vertex of the fed printing medium and an index value of the light receiving element disposed at a location which meets an opposite other corner vertex of the fed printing medium, and calculating the skew quantity through comparing the number of counts and the stored index values stored.

The skew quantity may satisfy a following equation: Skew quantity=arctan(Y/X)X=(i_cw−i_ccw)×(w+d)+m Y=f×V×T where i_cw is an index value of the light receiving element disposed at a location which first meets a corner vertex of the fed printing medium and i_ccw is an index value of the light receiving element disposed at a location which meets an opposite other corner vertex of the fed printing medium, w is the width of the light receiving element, d is the interval between the light receiving elements, m is a margin that compensates to consider when the edge of the fed printing medium covers one light receiving element or the interval, f is a number of counts counted during an entering of the printing medium from the first entering of the corner vertex of the fed printing medium till the last entering of the other corner vertex of fed printing medium, V is a feeding speed of the fed printing medium, and T is a detecting period of the light receiving element.

The determining the skew quantity of the fed printing medium may further include discerning whether the skew quantity is changed while transporting the fed printing medium, and calculating the skew quantity at a predetermined target location if the skew quantity changes.

The discerning of the skew quantity change may include calculating the respective skew quantities of the fed printing medium through a first detecting unit and a second detecting unit which respectively have a plurality of light receiving elements arranged in the width direction of the fed printing medium at a first location and a second location of the medium transport path, and deciding whether the skew quantity is changed by comparing the skew quantities detected in the first and second detecting units.

The skew quantity at the target location may be calculated by using a following equation: Δθ₂=Δθ₁×(1+d₂/d₁) where Δθ₂ is a difference of the skew quantity at the target location from the first location, Δθ₁ is a difference of skew quantity at the second location from the skew quantity at the second location, d₁ is the distance from the first location to the second location, and d₂ is the distance from the second location to the target location.

The determining the shift quantity of the fed printing medium may include deciding which light receiving elements among the plurality of the light receiving element located at left and right parts of leading edge of the fed printing medium detect the fed printing medium, storing the output values from the corresponding light receiving elements respectively located at the left and right top boundary of the fed printing medium in a first index (i_cw) and (i_ccw), and calculating the shift quantity of the printing medium at a location of the light receiving elements through comparing the stored values in the first index and the second index.

The shift quantity may satisfy a following equation: shift quantity=[(i_cw+i_ccw)/2−i_cnt]×(w+d)+m where w is the width of each light receiving element, d is an interval between each light receiving element, m is a margin and i_cnt is an index value at a center. If the shift quantity from equation (9) is negative, the printing medium is shifted to left side, and if the shift quantity from equation (9) is positive, the printing medium is shifted to right side.

The determining the shift quantity of the fed printing medium may further include discerning whether the shift quantity is changed while transporting the printing medium, and calculating the shift quantity at a predetermined target location if the shift quantity changes.

The discerning of the shift quantity change may include calculating the respective shift quantities of the fed printing medium through a first detecting unit and a second detecting unit arranged in the width direction of the fed printing medium at a first location and a second location of the medium transport path, and deciding whether the shift quantity is changed by comparing the shift quantities detected in the first and second detecting units.

The shift quantity at the target location may be calculated by using a following equation: ΔS₂=ΔS₁×(1+d₂/d₁) where ΔS₂ is a difference of the shift quantity at the target location from the shift quantity at the first location, ΔS₁ is a difference of the shift quantity at the second location from the shift quantity at the first location, d₁ is the distance from the first location to the second location, and d₂ is the distance from the second location to the target location.

The image output method of the image forming apparatus may further include determining whether the format of the fed printing medium corresponds with a medium format set by a user, and notifying an incompatibility to a user if the format does not correspond to the set format.

The foregoing and/or other aspects an utilities of the present inventive concept can also be achieved by providing an image forming apparatus, including an image forming unit to form an image onto a printing medium while being fed into the image forming unit, a medium detecting device to detect contour form information corresponding to the printing medium, and an exposure unit to adjust an image signal based on the detected contour form information to print the image onto the printing medium without the image being skewed or shifted on the printing medium.

The exposure unit may adjust the image signal in response to at least one of a size, a skew quantity and a shift quantity of the printing medium.

The image forming apparatus may further comprise a plurality of light receiving elements to receive light from a light source depending on an interference of the printing medium.

The exposure unit may adjust the image signal based on the light received by the plurality of light receiving elements.

The foregoing and/or other aspects an utilities of the present inventive concept can also be achieved by providing an image forming method, comprising feeding a printing medium into an image forming unit, detecting contour form information corresponding to the printing medium, and adjusting an image signal based on the detected contour form information to print an image onto the printing medium without the image being skewed or shifted on the printing medium.

The adjusting of the image signal may occur in response to at least one of a size, a skew quantity and a shift quantity of the printing medium.

The method may further comprise receiving light from a light source depending on an interference of the printing medium.

The adjusting of the image signal may be based on the received light.

### BRIEF DESCRIPTION OF THE DRAWINGS

The above and/or other aspects and utilities of the present general inventive concept will become apparent and more readily appreciated from the following description of the exemplary embodiments, taken in conjunction with the accompanying drawings, in which:

FIG. 1 is an image forming apparatus employing a medium detecting device according to an exemplary embodiment of the present general inventive concept;

FIG. 2 is a schematic perspective view illustrating the medium detecting device of FIG. 1 according to an exemplary embodiment of the present general inventive concept;

FIG. 3 is a schematic view illustrating a configuration of a detecting unit according to an exemplary embodiment of the present general inventive concept;

FIG. 4 is a graph illustrating an output of the detecting unit of FIG. 3 dependent on a coverage rate by a printing medium;

FIG. 5 is a view illustrating a printing medium and a width of a photosensitive body which is a reference of an inner design rule of the image forming apparatus by an available length S, a skew quantity and a shift quantity;

FIG. 6A is a schematic perspective view illustrating the medium detecting device according to another exemplary embodiment of the present general inventive concept;

FIG. 6B is a view illustrating an arrangement of the detecting unit when an interference occurs by a printing medium;

FIG. 7 is a schematic plan view illustrating the printing medium without a skew and an arrangement of the medium detecting device according to an exemplary embodiment of the present general inventive concept;

FIGS. 8A through 8E are enlarged views of a region VIII of FIG. 7 illustrating a printing medium feeding process order when no skew exists;

FIG. 9 is a graph illustrating a light receiving element output according to a sequential change of time in FIG. 8A through FIG. 8E;

FIG. 10 is a view illustrating an example of transporting the printing medium shifted right by as much as 10.5 mm from a reference feeding line;

FIG. 11 is a schematic plan view illustrating the skewed printing medium and an arrangement of the medium detecting device according to an exemplary embodiment of the present general inventive concept;

FIGS. 12A through 12D are respective enlarged views of a region XII of FIG. 11 illustrating the printing medium feeding process order of the skewed and shifted printing medium when the printing medium is transported;

FIG. 13 is a graph illustrating the light receiving element output according to a sequential change of time in FIGS. 12A through 12D;

FIG. 14 is a schematic cross sectional view illustrating a medium detecting device according to another exemplary embodiment of the present general inventive concept;

FIG. 15 is a view explaining a difference in shifted length at a transfer location Pz from a shift length Q_{sf1} at a first location Px in FIG. 14;

FIG. 16 is a view explaining a difference in skew quantity at a transfer location Pz from a skew quantity Qₛₖ₁ at a first location Px in FIG. 15;

FIG. 17 is a view explaining a relation of X, Y and a width of the printing medium P_{width};

FIG. 18 is a view illustrating a corner vertex of the skewed printing medium entering an interval between the i−1^{th} and i^{th} light receiving elements.

FIG. 19 is a schematic view illustrating a single path type electro-photographic color image forming apparatus according to an exemplary embodiment of the present general inventive concept;

FIG. 20 is a view illustrating a color registration device according to the exemplary embodiment of FIG. 2 of the present general inventive concept;

FIG. 21 is a view illustrating a color registration device according to the exemplary embodiment of FIGS. 6A through 6E of the present general inventive concept; and

FIG. 22 is a view illustrating a relation of a first and a second test patterns arrangement of the color registration device according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

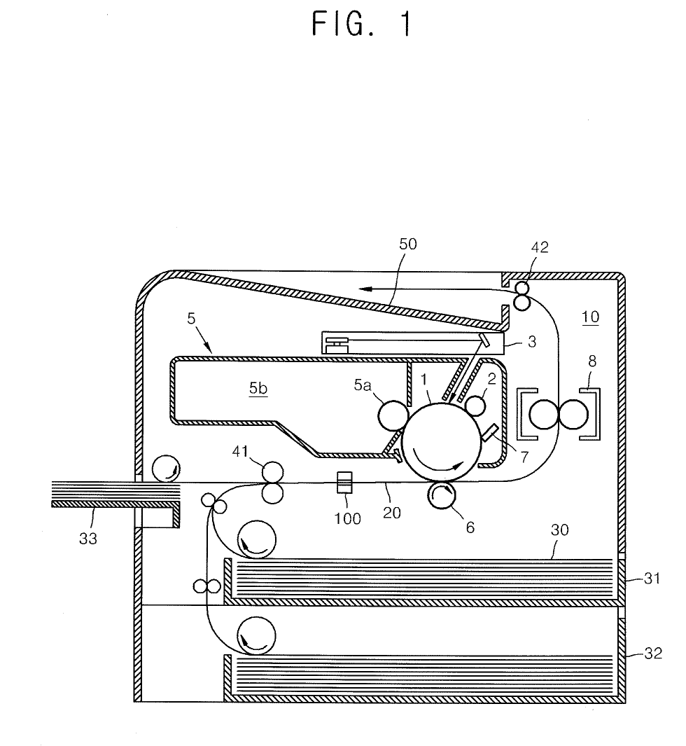

FIG. 1 illustrates an example of an image forming apparatus employing a medium detecting device 100 according to an exemplary embodiment of the present general inventive concept.

Referring to FIG. 1, the image forming apparatus according to the exemplary embodiment of the present general inventive concept is equipped with an image forming unit 10 that prints an image on a printing medium 30 by an electro-photographic method, a plurality of printing medium feed units 31, 32 and 33, and the medium detecting device 100.

The image forming unit 10 includes a photosensitive body 1, a charger 2, an exposure unit 3, a development unit 5, a transfer unit 6, a cleaning blade 7 and a fusing unit 8. The image forming unit 10 may be installed with a restricted size according to its intended purpose. Thus a maximum available size of the printing medium 30 to be used in the image forming unit 10 may be limited by a physical size of the image forming unit 10.

The photosensitive body 1 of a cylindrically-shaped drum is formed with a photo conductive layer on its outer circumferential surface. The charger 2 may include a charge roller of a structure as illustrated in FIG. 1, or a corona discharger (not illustrated). The charger 2, which is disposed in a contacted state or a non-contacted state with the photosensitive body 1, supplies a charge to the photosensitive body 1 and charges the outer circumferential surface of the photosensitive body 1 to be at a uniform electric potential level.

The exposure unit 3 forms an electro-static latent image by radiating a light corresponding to image information on the photosensitive body 1. The exposure unit 3 may include for example a light scanning unit having a structure that can scan the light radiated from a light source by a beam deflector.

The development unit 5 includes a development roller 5a and a toner chamber 5b to accommodate a toner inside of it and develops a toner image corresponding to the electro-static latent image.

The development roller 5a rotates and contacts the outer circumferential surface of the photosensitive body 1, or is separated from the outer circumferential surface of the photosensitive body 1 by a development gap. The development gap may be approximately from several tens to several hundreds micrometers wide. The development roller 5a supplies the toner accommodated in the toner chamber 5b to the electro-static latent image formed on the photosensitive body 1, and is applied with a development bias voltage to form the toner image.

The transfer unit 6 is disposed to face the photosensitive body 1 and transfers the toner image formed on the photosensitive body 1 to the printing medium 30.

The cleaning blade 7 removes a waste toner remaining on the photosensitive body 1 after transferring the toner image to the printing medium 30. The fusing unit 8 presses and heats up a non-fused toner image transferred by the transfer unit 6 on the printing medium 30 to be fused on the printing medium 30.

An image forming process of the image forming apparatus configured as mentioned will be described as follows. First, the photosensitive body 1 is charged with the uniform electric potential. If a light signal corresponding to the screen image information is scanned by the exposure unit 3, the electro-static latent image is formed on the photosensitive body 1 surface as an electric potential level of a part scanned by the light beam is decreased. Subsequently, the toner image is formed by attaching the toner on the electro-static latent image if the development bias voltage is applied to the development roller 5a.

Further, the printing medium 30 drawn out from the printing medium feed units 31, 32 and 33 is transported to the image forming unit 10 through a medium transport path 20 in a predetermined transfer speed by a transfer roller 41.

An arrival of the printing medium 30 to a transfer nip is adjusted at a time when a leading edge of the toner image formed on the photosensitive body 1 arrives at the transfer nip facing the photosensitive body 1 and the transfer unit 6. Accordingly, if the transfer bias voltage is applied to the transfer unit 6, the toner image is transferred from the photosensitive body 12 to the printing medium 30. After the printing medium transferred with the toner image passes the fusing unit 8, a printing of an image is completed through fusing the toner image on the printing medium 30 by heat and pressure. Then, the printing medium 30 with the image formed thereon is then discharged by a discharge roller 42 and is accumulated in a discharge tray 50.

The image forming apparatus according to an exemplary embodiment of the present general inventive concept includes an ink-jet type image forming apparatus as an alternative to the electro-photographic type image forming apparatus of the above configuration. This ink-jet type image forming apparatus includes a cartridge including an inkjet head, a carriage to transport the cartridge and a cartridge driving unit, but a configuration of the ink-jet type image forming apparatus is well known in the art and therefore an explanation thereof will be omitted.

Hereinafter, the medium detecting device 100 according to an exemplary embodiment of the present general inventive concept will be explained in detail.

The printing medium feed units 31, 32 and 33 may be classified as a cassette type and a multi-purpose feeder type according to their shapes.

In FIG. 1, first and second printing medium feed units 31 and 32 of the cassette type are loaded with the printing medium of standard formats such as generally B4, B5, A4, A5, etc. The respective first and the second printing medium feed units 31 and 32 can selectively load the printing medium 30 of different standard formats by adjusting a medium guide (not illustrated) provided inside thereof according to a side feeding direction or center feeding direction. Here, the side feeding direction transports the printing medium 30 based on one end edge of the printing medium 30 vertical to its width direction as a transport reference. In contrast, the center feeding direction transports the printing medium 30 based on a center part of the printing medium 30 width as a transport reference.

The third printing medium feed unit 33 is a multi purpose feeder (MPF) to load not only a printing medium having a standard format, but also a printing medium having a nonstandard format. More specifically, the third printing medium feed unit 33 is used to feed the printing medium 30 to print an image of a size different from the standard formats of the printing medium 30 used in the first and the second printing medium feed units 31 and 32, respectively.

A method to feed the appropriate printing medium 30 corresponding to the image size to be formed with a configuration of the first, second and third printing medium feeding units 31, 32 and 33 as described above is as follows.

A user designates the printing medium 30 fed from the first, second or third printing medium feed units 31, 32 and 33, respectively through an interface program of a computer connected to the image forming apparatus or a user interface tool of the image forming apparatus. At this time, a printing medium designation information designating the printing medium feed units 31, 32 and 33 is stored in a built in memory (not illustrated) in the image forming apparatus. Then, the image is printed on the appropriate printing medium 30 corresponding to the image size fed from the first, second or third printing medium feed unit 31, 32 or 33, respectively, based on the stored printing medium designation information.

If a user loads the printing medium 30 different from the designation information stored in the memory when loading the printing medium 30 in the first, second or third printing media feed unit 31, 32 and 33, a poor printing may be resulted.

For example, when the designation information designates the first, second and the third printing medium feed units 31, 32 and 33 to be loaded with the printing media 30 of standard formats A4, B4 and B5 respectively, the first, second and the third printing medium feed units 31, 32 and 33 may be loaded with the printing media 30 of standard formats B4, A4 and B5, respectively.

Then, if an image of the size A4 is to be printed, the printing medium 30 of size B4 may be drawn out from the first printing medium feed unit 31 following the stored designation information. This will not cause a loss of the image since the standard format of the printing medium 30 is larger than the image size, but will result in a waste of the printing medium 30 and a problem of printing on the printing medium 30 at a size that a user does not want.

Further, if an image of the size B4 is to be printed, a printing medium 30 of size A4 smaller than B4 may be drawn out from the second printing medium feed unit 32 following the stored designation information. This will cause a loss of the image since the standard format of the printing medium 30 is smaller than the image size and results not only in a waste in the printing medium 30, but also a problem of polluting units or elements included in the image forming apparatus.

The medium detecting device 100, according to an exemplary embodiment of the present general inventive concept, is included to solve the problem of inappropriate feeding of the printing medium 30 and to correctly control an operation of forming an image by detecting a feeding characteristic of the fed printing medium 30.

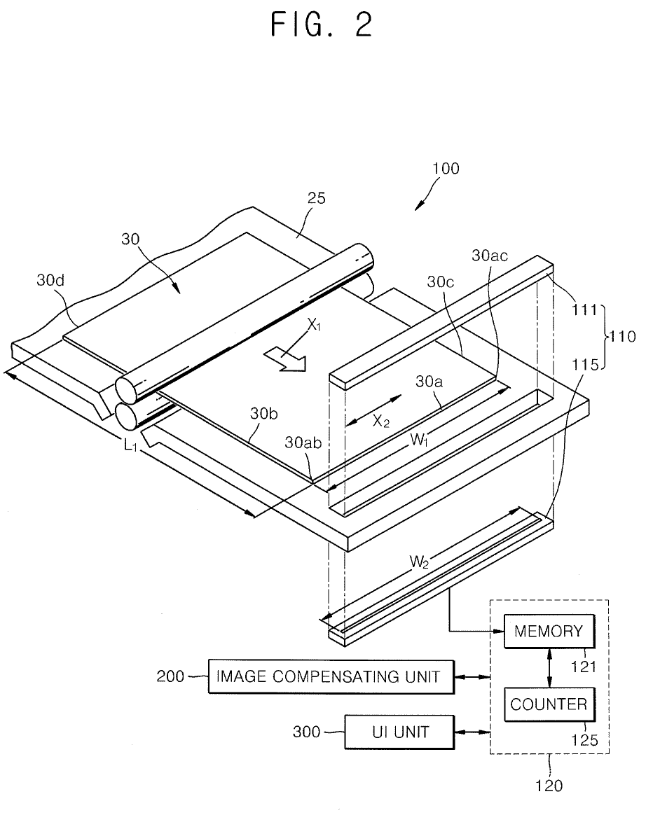

Referring to FIGS. 1 and 2, the medium detecting device 100 according to an embodiment of the present general inventive concept includes a detecting unit 110 that detects contour form information of the printing medium 30 being transported in a printing medium feeding direction (X₁ direction indicated as an arrow), and a discriminating unit 120 that determines a format of the printing medium 30 and a feeding position. Here, the contour form information represents an appearance of the printing medium 30 and includes not only an overall appearance but also a partial appearance of the printing medium 30. For example, the contour form information includes the appearance of the overall printing medium 30 as illustrated, as well as separate parts of the printing medium 30 including a leading edge 30a and opposite side edges 30b and 30c.

The detecting unit 110 is arranged across a width W₂ which is larger than a maximum permitted width W₁ of the printing medium 30 in a direction X₂ parallel to the width direction of printing medium 30 on a guide frame 25, which is provided in the medium transport path 20. Accordingly, occurrence of a detecting error during detection of the size of the printing medium 30 can be reduced.

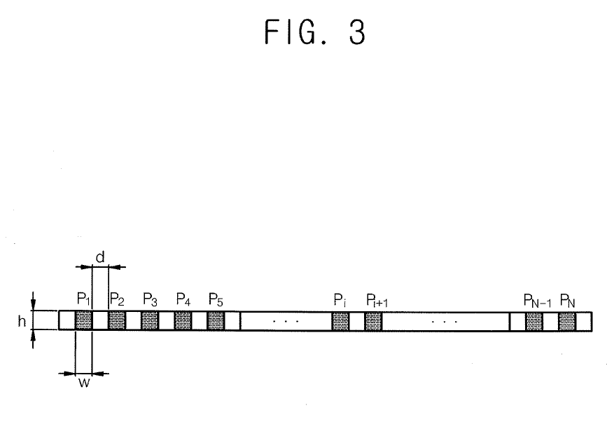

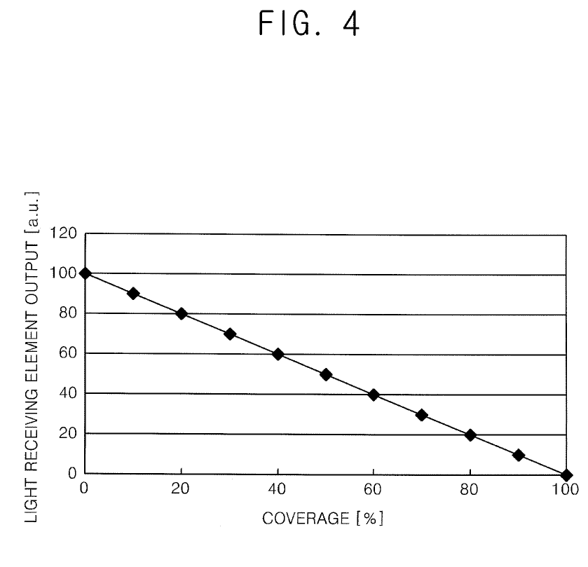

FIG. 3 illustrates a schematic configuration of the detecting unit 110 of FIG. 2, and FIG. 4 is a graph displaying an output of the detecting unit 110 dependent on a coverage rate by the printing medium 30.

Referring to FIGS. 2 and 3, the detecting unit 110 includes a light source 111 to radiate a light, and a light receiving element 115 to selectively detect the radiated light from the light source 111 dependent on an existence of the printing medium 30.

Here, the light receiving element 115 as illustrated in FIG. 3, includes a plurality of the light receiving elements 115 (i.e., P₁, P₂, . . . , Pᵢ, Pᵢ₊₁, . . . , Pₙ₋₁, Pₙ) consecutively arranged in one line along the print medium 30 width direction X₂. Then, positions information of the printing medium 30 facing the plurality of the light receiving element 115 on the one line may be detected simultaneously.

Also, since the printing medium 30 is being fed on the frame guide 25 in the X₁ direction, the light receiving element 115 can continuously detect the contour information of the printing medium 30 line by line. Accordingly, the contour form information, which is a two-dimensional contour form information of the printing medium 30 including the width W₁, corner vertex positions 30ab, 30ac and the length L₁, may be detected as a form of an image. As a result, a size of the printing medium 30, a shift quantity and a skew quantity can be detected.

The medium detecting device 100 according to an exemplary embodiment may be configured with various kinds of devices corresponding to the light receiving elements 115. For example, the light receiving element 115 may include a widely used photo sensor, a solar cell, a mechanical detecting device, etc. The light receiving elements 115 (P₁, P₂, . . . , Pᵢ, Pᵢ₊₁, . . . , Pₙ₋₁, Pₙ) are of a same size and are represented by the height h and the width w respectively. Each of the light receiving elements 115 (P₁, P₂, . . . , Pᵢ, Pᵢ₊₁, . . . , Pₙ₋₁, Pₙ) may be separated by a constant interval d.

In contrast, the light source 111 may be provided in plurality to correspond with the light receiving elements 115. Also, the light source 111 may be configured in a stripe type lamp structure arranged in the direction X₂ along the width W₁ of the printing media 30. The light source 111 may also have a configuration including a bulb type lamp and an optical fiber to guide a light radiated from the bulb type lamp to the light receiving element 115.

Also, the detecting unit 110 may detect the printing medium 30 in a reflective manner. That is, the printing medium 30 may be detected by receiving the light reflected from the printing medium 30 by the light receiving element 115 with an adjacent arrangement of the light source 111 with the light receiving element 115 if the printing medium 30 exists.

Since the detail configuration of the light source 111 and the light receiving element 115 is well known in the art, a detailed description thereof is omitted.

Meanwhile, as illustrated in FIG. 2, if the light source 111 and the light receiving element 115 face each other when leaving the medium transport path 20 therebetween, the light from the light source 115 is radiated toward the light receiving element 115 until the printing medium 30 enters the medium transport path 20 between the light source 111 and the light receiving element 115. After the printing medium 30 enters the medium transport path 20, the light from the light source 111 is blocked by the printing medium 30. This change is presented as an electrical signal (for example, a current) output from the light receiving element 115, and becomes a reference information of calculating data corresponding to the printing medium 30 in the discriminating unit 120.

That is, since respective efficiencies of the plural light receiving elements 115 (P₁, P₂, . . . , Pᵢ, Pᵢ₊₁, . . . , Pₙ₋₁, Pₙ) are not different, a summed output signal may be a value corresponded to an area covered by the printing medium 30. In other words, an output value p of a detected signal satisfies a following equation 1.

p=c×A Equation 1

where c is a proportional constant and A is total area of the light receiving element 115 covered by the printing medium 30.

When calculating the output value p, an error from the interval d between the light receiving elements 115 may be reduced by narrowing the interval d, and the output value p may be compensated by linearly connecting the detected values between adjacent light receiving elements 115.

Referring to FIG. 4, the output from the plural light receiving elements 115 (P₁, P₂, . . . , Pᵢ, Pᵢ₊₁, . . . , Pₙ₋₁, Pn) is proportional to an area of the light incident to the light receiving element 115. Thus, if the output of the light receiving elements 115 is 100 when all the light receiving elements 115 (P₁, P₂, . . . , Pᵢ, Pᵢ₊₁, . . . , Pₙ₋₁, Pₙ) are uncovered by the printing medium 30 (coverage rate=0%), the output is reduced linearly with the increase of the coverage rate. Therefore, the output of the light receiving elements 115 turns out to be 0 when the light receiving elements 115 are covered by the printing medium 30 (coverage rate=100%).

The light receiving elements 115 (P₁, P₂, . . . , Pᵢ, Pᵢ₊₁, . . . , Pₙ₋₁, Pₙ) may be arranged to be adjacent to each other. In other words, the adjacent light receiving elements 115 may be arranged without any separation by the interval d or may be arranged within a predetermined interval d less than the width of the light receiving element 115 in its arranged direction. This results in a precise detection of the shift quantity and the skew quantity of the fed printing medium 30.

If the light from the light source 111 is not covered by the printing medium 30, the respective light receiving elements 115 may ideally have a same output value of a current since the respective light receiving elements 115 receive a same amount of the light. In contrast, there may be a variation in the output current values because of a difference in respective efficiencies of the light receiving elements 115 and a light interference by the diffraction of the radiated light but the variation may be adjusted considering a detecting error. Hereinafter, an ideal case will be illustrated.

A length of the detecting unit 110 from the arrangement of the plurality of light receiving elements 115 (P₁, P₂, . . . , Pᵢ, Pᵢ₊₁, . . . , Pₙ₋₁, Pₙ) may be determined by considering the shift quantity, the skew quantity and the maximum width of the printing medium 30, which is adaptable to the image forming apparatus.

The shift quantity denotes an amount of a deviation in a width direction from the regular medium transport path 20. For example, the shift quantity is represented as +5 mm if the printing medium 30 is shifted by 5 mm right from a reference position in a normal transport path, and as −5 mm if shifted 5 mm left from the reference position.

If the printing medium 30 is deviated beyond a permitted shift quantity when the printing medium 30 is transported, a part of the printing medium 30 is deviated from an image forming area and the image will not be normally formed. A faulty printing may be prevented by controlling the image forming apparatus by presetting the permitted shift quantity in advance and determining whether the shift quantity measured in the medium detecting device 100 is within the permitted quantity.

Skew quantity signifies a rotated angle of the printing medium 30 with respect to the progressing direction X₁ when the printing medium 30 moves in the progressing direction X₁. The printing medium 30 may be formed as a rectangle shape with vertices of right angles.

The leading edge 30a of the printing medium 30 can form a right angle to the printing medium 30 progressing direction X₁. However, the leading edge 30a of the printing medium 30 may be rotated by some angle when it is transported. For example, a clockwise 5° rotation of the leading edge 30a of the printing medium 30 may be represented as +5° and a counter clockwise 5° rotation as −5°. Accordingly, the skew quantity may be measured with a reference by the leading edge 30a of the printing medium 30 or the center line of the printing medium 30 progressing direction.

For convenience in describing the exemplary embodiment, the shift quantity and the skew quantity are defined with the leftmost side edge 30c and the leading edge 30a as references, respectively. The references are selected arbitrarily and any other positions defined as a reference corresponding to the shift and the skew quantities are within a range of the scope of the present general inventive concept.

Even if the skew quantity varies in maximum range from −90° to +90°, a photosensitive body 1 can rotate to correspond with the skew quantity to form a toner image on the photosensitive body 1 and then correctly form the image on the printing medium 30. Meanwhile, the printing medium 30 is rarely transported with the skew quantity range in excess of ±45°, then, a permitted skew quantity may be set within a predetermined range considering a transport characteristic and loading capability after discharging the printing medium 30. Thus, permitted ranges of the shift quantity and the skew quantity have to consider the size of the usable printing medium 30, especially the printing medium 30 width direction length, in designing the image forming apparatus.

Hereinafter, the inner standards rule corresponding to the printing medium 30 and the image forming apparatus which is the width direction length served as a reference to design the photosensitive body 1 is defined as an available length S.

The available length S serving as a reference to design the image forming apparatus may be determined from the maximum width W₁ of the printing medium 30, the total permitted shift quantity and the permitted skew quantity.

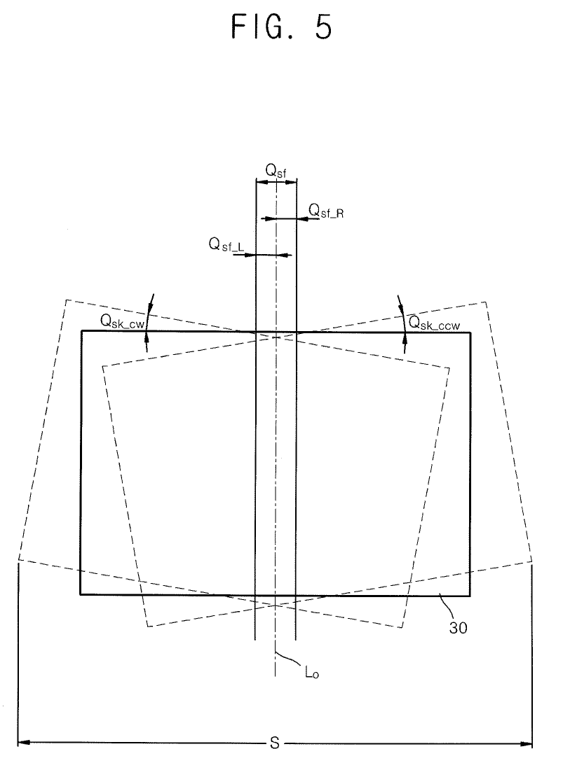

Referring to FIG. 5, a specific determination of the available length S is as follows.

For convenience of description, the printing medium 30 of A4 standard format is set as a maximum possible standard format, the permitted shift quantity is 10% of the maximum width W₁ of the printing medium 30, the permitted skew quantity is ±10°, and the image forming apparatus designed to feed the printing medium 30 in a center feeding way feeding along a center line L₀ as a reference will be explained. The available length S is a length summed with the maximum width W₁ and the maximum permitted shift quantity. The permitted skew quantity is restricted by the shift quantity of the printing medium 30.

The A4 standard format size is 210×297 mm², and since a landscape printing or a portrait printing is possible, the maximum printing width W₁ is 297 mm. A maximum permitted shifted quantity Q_{sf} is 10% of the maximum with 29.7 mm. The shifted quantity is produced in right and left directions so right and left permitted shift quantities Q_{sf}_{_{—}}_{R} Q_{sf}_{_{—}}_{L} are 29.7/2=14.85 mm. The available length S is 326.7 mm (S=297+14.85×2).

Accordingly, if the available length S is 326.7 mm when designing the image forming apparatus according to the exemplary embodiment, the printing on the A4 printing medium 30 is possible if the printing medium 30 is transported within the shift quantity 29.7 mm and the skew quantity ±10°.

Referring to FIG. 2, the discriminating unit 120 includes a memory 121 that stores information regarding a format of the printing medium 30 and relative positions of the plurality of light receiving elements 115, and a counter 125 that is used to calculate a transport time required by the printing medium 30.

Information regarding respective positions of the light receiving elements 115 (P₁, P₂, . . . , Pᵢ, Pᵢ₊₁, . . . , Pₙ₋₁, Pₙ) and the intervals d between the each of the light receiving elements 115 are stored through matching in an imaginary coordinate.

Accordingly, the discriminating unit 120 discriminates information regarding exact positions and the format of the fed printing medium 30 through the detected signals of the respective light receiving elements 115 and the stored information in the memory 121 from the light receiving elements 115. That is, the detecting signal of 0% at the position of the light receiving element 115 means the covering of the printing medium 30 at that position while the detecting signal of 100% means the uncovering at that position.

The counter 125 calculates the transporting time of the printing medium 30 between its leading edge 30a and a trailing edge 30d.

Accordingly, the discriminating unit 120 compares the detected format information of the fed printing medium 30 from the detecting unit 110 with standard format information stored in the memory 121 and the information on the light receiving element 115, and can determine the standard format of the fed printing medium 30. In other words, the discriminating unit 120 can determine the two dimensional contour form information including lengths in width and lengthwise directions of the printing medium 30 fed to the discriminating unit 120 and the fed position.

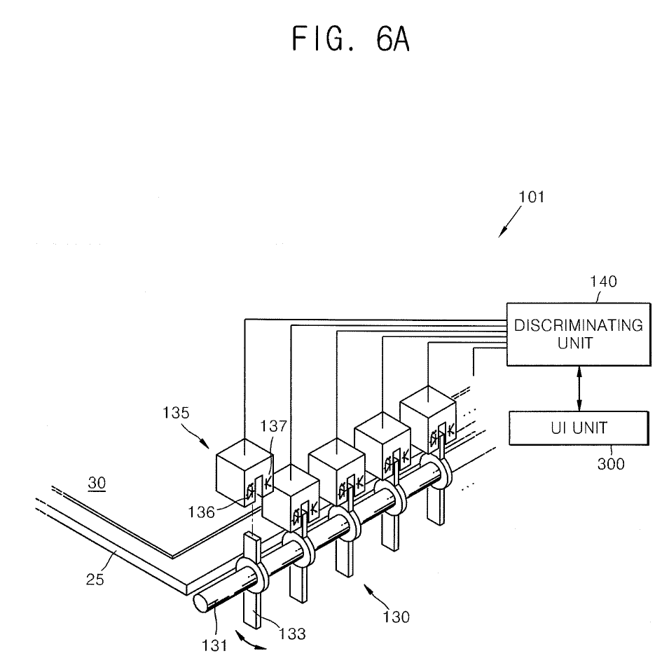

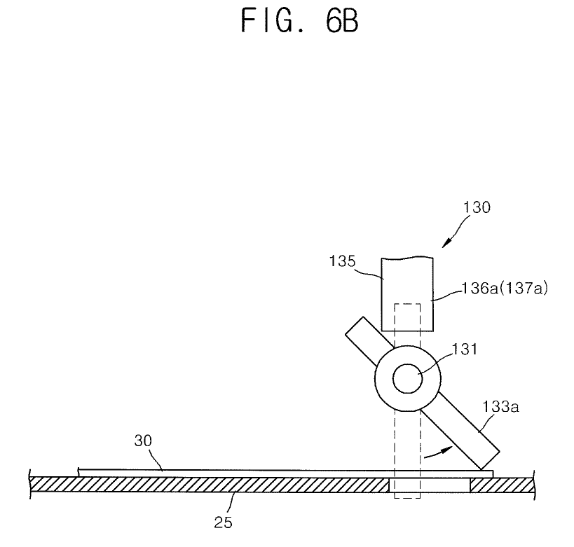

FIG. 6A is a schematic perspective view illustrating a main part of a medium detecting device 101 according to another exemplary embodiment of the present general inventive concept, and FIG. 6B is a view illustrating an arrangement of the medium detecting device 101 when a printing medium 30 is contacted.

Referring to FIGS. 6A and 6B, the medium detecting device 101, according to another exemplary embodiment, includes a detecting unit 130 to detect a format and a feeding position of the printing medium 30 and a discriminating unit 140 to determine a standard format and a fed position of the printing medium 30. The detecting unit 130 detects the information of the printing media 30 by contacting the printing medium 30 in a different manner from the former exemplary embodiment.

The detecting unit 130 includes a shaft 131 arranged in a width direction of the printing medium 30 on a medium transport path where the printing medium 30 is being fed, a plurality of sensing bars 133 installed on the shaft 131 to be rotated freely and a plurality of sensors 135 that sense respective rotation states of the sensing bars 133.

The sensing bars 133 are arranged vertically as illustrated in FIG. 6A by their own weight when there is no contact with the printing medium 30. Further, the sensor 135 includes a light emitting element 136 and a light receiving element 137 that face each other and leave the sensing bar 133 therebetween. Accordingly, when there is no feeding of the printing medium 30, the light receiving element 137 cannot detect a light signal since a light emitted from the light emitting element 136 is blocked by the sensing bar 133.

When the printing medium 30 is being fed, as illustrated in FIG. 6B, and contacts at least one of the plurality of sensing bars 133, a sensing bar 133a contacting with the printing medium 30 rotates by the shaft 131 as a rotation axis and stops blocking the light. Then, a light receiving element 137a can detect whether the printing medium 30 is being fed. The light receiving element 137a can also detect the shift and the skew quantities of the printing medium 30 by receiving the light emitted from a correspondent light emitting element 136a.

Since the discriminating unit 140 is substantially the same as the discriminating unit 120 of the exemplary embodiment of FIG. 2, a detailed description of the discriminating unit 140 will be omitted.

The configuration of the detecting unit 130 in another exemplary embodiment is different from the detecting unit 110 in the exemplary embodiment of FIG. 2, and contour form information can be obtained in a same principle as the medium detecting device 100 according to the embodiment of FIG. 2, since an interference of the printing medium 30 can be sensed even when the light receiving element 137 detects the signal if the printing medium 30 is positioned properly to correspond to the light receiving element 137.

Hereinafter, an operation of the medium detecting devices 100 and 101 according to various exemplary embodiments of the present general inventive concept will be explained by describing situations where the printing medium 30 has a skew or has no skew.

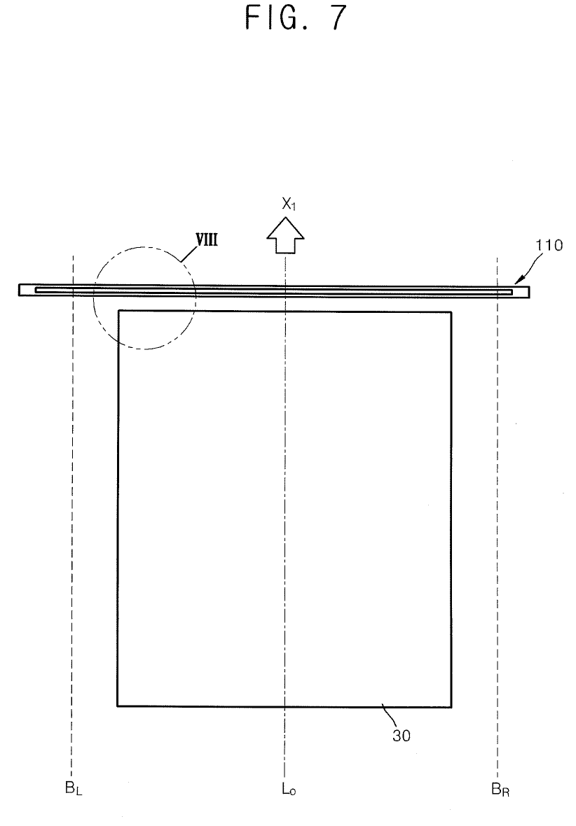

FIG. 7 is a schematic plan view illustrating the printing medium 30 without a skew and an arrangement of the medium detecting devices 100 and 101.

In the present exemplary embodiment, as illustrated in FIG. 7, an image forming apparatus directs the printing medium 30 of A4 standard format (210 mm×297 mm) in a lengthwise X₁ direction. Accordingly, a center feeding method that feeds the printing medium 30 with a center line L₀ as a reference, the 10% permitted shift quantity, the ±10° permitted skew quantity are assumed. B_{L} denotes a left side boundary and B_{R} denotes a right side boundary.

In addition, print width=210 mm, shift quantity=21 mm(=210×10%), and available length=231 mm(=print width+shift quantity+skew quantity(=0°) are set. Sizes of configuring elements related to the width of the printing medium 30 are determined by the available length S as their reference.

Also, the size of the light receiving element 115 is determined by height h=1 mm and width w=1 mm of rectangular shape and sets an interval d between the light receiving elements as 1 mm.

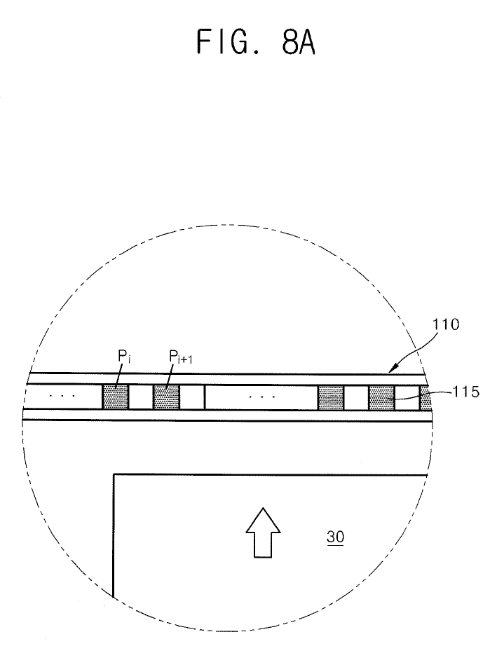

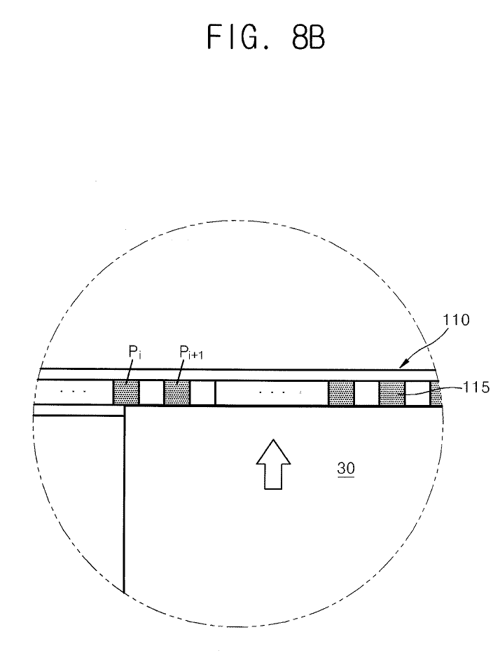

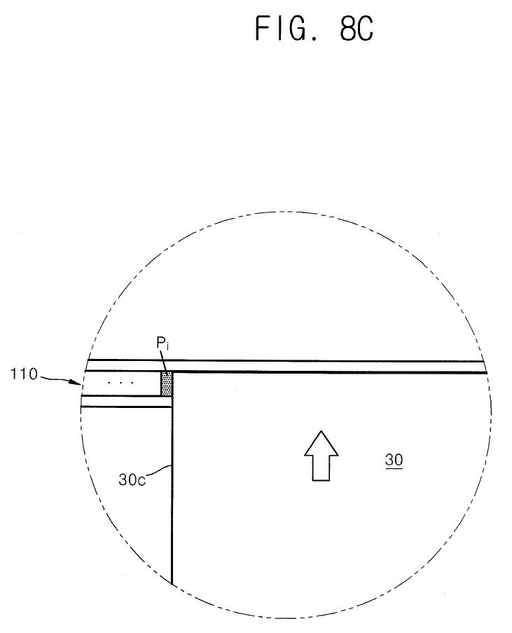

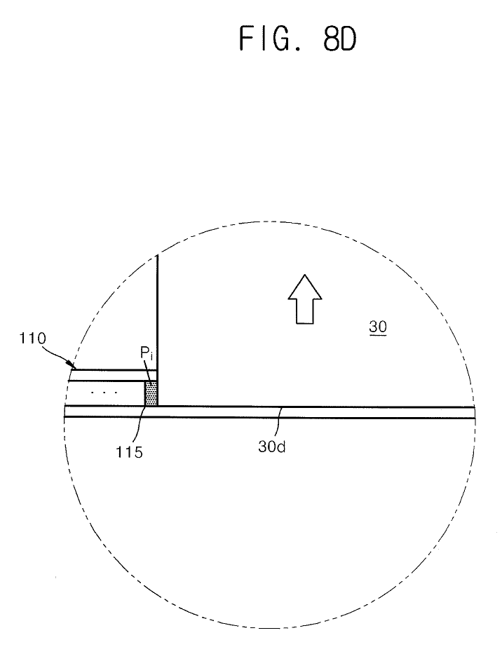

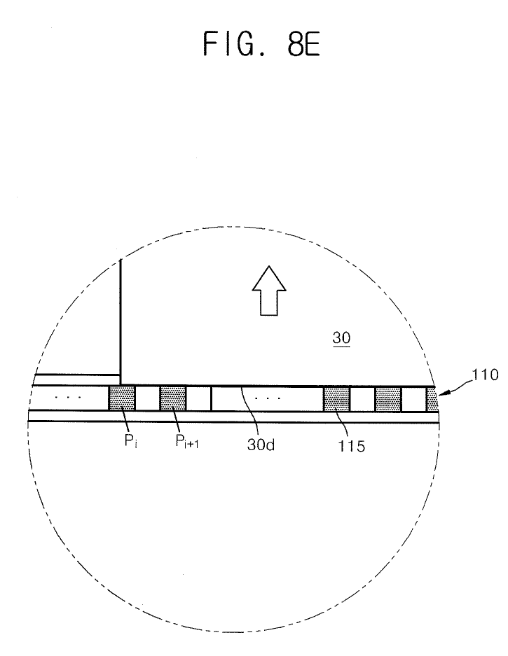

FIGS. 8A through 8E are enlarged views of a region VIII of FIG. 7 illustrating a feeding process order of the printing medium 30 when there is no skew after configuring the medium detecting devices 100 and 101 as mentioned above.

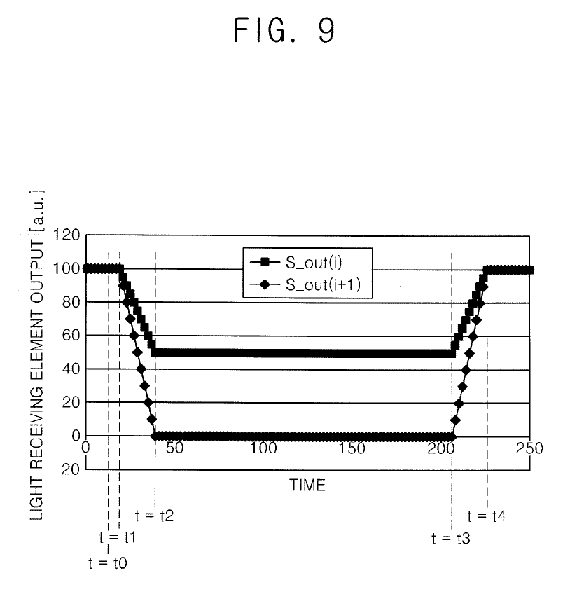

FIG. 9 is a graph illustrating an output of the light receiving element 115 according to a time sequence. In FIG. 9, S_out(i) is an output value of the light receiving element 115 (Pᵢ) and S_out(i+1) is an output value of the light receiving element 115 (Pᵢ₊₁).

FIG. 8A illustrates a state (t=t0) before the printing medium 30 enters the detecting unit 110. At this state, all output values of the i^{th} light receiving element and the i+1^{th} light receiving element are 100%.

As illustrated in FIG. 8B, as the printing medium 30 is transported during time t1 and covers a portion of the light receiving element 115, the output values of the i^{th} and the i+1^{th} light receiving element Pᵢ and Pᵢ₊₁ start to decrease. Considering an arrangement direction of the light receiving element 115, the i^{th} light receiving element Pᵢ is covered partially in its lengthwise direction by the printing medium 30 while the i+1^{th} light receiving element is covered entirely across the lengthwise direction. More specifically, the decreasing rates of the output values are different. That is, the output value decreasing rate of the i+1^{th} light receiving element Pᵢ₊₁ is larger than that of the i^{th} light element light receiving element Pᵢ.

As time elapses from time t=t₀ to t=t₁, an exact time of the printing medium 30 entering the medium detecting device 100 can be detected from a change in output values. A mapping of the printing medium 30 is performed on the reference coordinate determined by the position information of the light receiving element 115. The mapping includes a process of detecting and recognizing the related information of the printing medium 30 by comparing a length in the width direction, the shifted quantity and a length in the lengthwise direction of the printing medium 30 with the stored position information in the memory 121 of FIG. 2.

As illustrated in FIG. 8C, when the printing medium 30 is transported continuously till time t2, the i+1^{th} light receiving element Pᵢ₊₁ is completely covered by the printing medium 30. While, the i^{th} light receiving element Pᵢ is partially covered (for example 50% coverage rate) by the printing medium 30. Since t2 is the time when the complete covering of the light receiving element Pᵢ₊₁ is initiated, the discriminating unit 120 of FIG. 2 can recognize that the leading edge 30a of the printing medium 30 is positioned at the end part (reference line) of the light receiving element 115. Further, the leftmost side edge 30c of the printing medium 30 may be recognized to be positioned across the center part of the i^{th} light receiving element Pᵢ from the 50% output value of the i^{th} light receiving element Pᵢ.

Also, a number n of the light receiving element 115 interfered 100% by the printing medium 30 with the known width w and the interval d of 1 mm respectively, and the width of the printing medium 30 which is 210 mm may be calculated by the following Equation 2.

n=210−(0.5+g+m) Equation 2

where g is a number of intervals and m is a margin.

The number of intervals g has a value equal to n or n±1. The margin m is a compensating value to consider when the right edge of the printing medium 30 partially covers one of the light receiving elements 115 or one of the intervals d.

FIGS. 8A through 8E illustrate the i^{th} light receiving element Pᵢ being partially interfered while its right side interval d is completely interfered by the printing medium 30. Accordingly, if n and m are 104 and 105, respectively, a value of 0.5+g+n is 209.5 mm. Further in order to extend the entire 210 mm by the light receiving element 115, the interval d of length 1 mm between the i+104^{th} light receiving element and the i+105^{th} element will be completely covered by the printing medium 30, and the rightmost side edge 30b of the printing medium 30 corresponding to the margin m=0.5 extends over a center of the i+105^{th} light receiving element.

Then, in the mentioned medium detecting device 100, the opposite side edges 30c and 30b of the printing medium 30 respectively cover the centers of the i^{th} and i+105^{th} light receiving elements while the printing medium 30 is fed.

Table 1 lists changes of output values of the respective light receiving elements with respect to time as the printing medium 30 is fed, as mentioned above.

TABLE 1

| | Pᵢ₋₁ | Pᵢ | Pᵢ₊₁ | . . . | Pᵢ₋₊₁₀₄ | Pᵢ₊₁₀₅ | Pᵢ₊₁₀₆ |
|---|---|---|---|---|---|---|---|
| t1 | 100 | 100 | 100 | 100 | 100 | 100 | 100 |
| (t1 + t2)/2 | 100 | 75 | 50 | 50 | 50 | 75 | 100 |
| t2 | 100 | 50 | 0 | 0 | 0 | 50 | 100 |

Referring to table 1, the i−1^{th} light receiving element Pᵢ₋₁ disposed left to the i^{th} light receiving element Pᵢ and the i+₁₀₆^{th} light receiving element Pᵢ₊₁₀₆ disposed right to the i+₁₀₅^{th} light receiving element Pᵢ₊₁₀₅ do not illustrate a change in their output values. Therefore, there is no interference to the light receiving element 115 by the printing medium 30.

The i^{th} light receiving element Pᵢ illustrates the output value 50% at time t2. Accordingly, the printing medium 30 is being transported along the center line of the i^{th} light receiving element Pᵢ. The output values of the i+1^{th} light receiving element Pᵢ₊₁ and the i+104^{th} light receiving element Pᵢ₊₁₀₄ are 0% respectively at time t2. Therefore, there is a complete interference to the light receiving element 115 by the printing medium 30.

Though a number of interfered light receiving elements 115 is represented in an ideal case to understand the operation principle, an exact length and the position of the printing media 30 can be calculated through a real time mapping of the detected values of the respective light receiving elements 115 to the coordinate in the discriminating unit.

At time t1, the leading edge 30a of the printing medium 30 is positioned at the reference line on the coordinate map and the printing medium 30 width is calculated. Further, the discriminating unit 120 continuously senses the outputs of the respective light receiving elements 115 as time passes and recognizes the light receiving element 115 that produce a change in the output value.

FIGS. 8D through 8E illustrate the trailing edge 30d of the printing medium 30 as it passes the medium detecting device 100. Since a detection of a signal of the trailing edge 30d is identical to the detection of the signal of the leading edge 30a, a detailed explanation thereof will be omitted.

When the printing medium 30 is arranged as illustrated in FIG. 8E, the discriminating unit 120 recognizes that the printing medium 30 has completely passed the medium detecting device 100 at time t4, and can calculate the length L₁ of the printing medium 30 using a feeding speed and the pass time.

For example, if the printing medium 30 is fed in speed 100 mm/s and the passing time is 2.97 s, the printing medium 30 length (=speed×pass time=100×2.97) is 297 mm.

As mentioned above, the media detecting device 100 can determine whether the printing medium 30 is normally fed by recognizing the shift amount, as well as the width and the length of the printing medium 30 through the discriminating unit 120.

In contrast, since the permitted shift amount is set to 10% of the width of the printing medium 30 in the present exemplary embodiment, the medium detecting device 100 needs additional light receiving elements 115 to detect the shift to the left side within the permitted shift quantity, not including the i^{th} light receiving element Pᵢ and the i+105^{th} light receiving element Pᵢ₊₁₀₅ which participate in the medium detection when there is a 0 shift quantity.

If the printing medium 30 is fed by the center feeding method, the permitted shift quantity is divided in half, and the left and right sides will have the permitted shift quantity as 10.5 mm respectively. Further, a mid point between the i^{th} light receiving element Pᵢ and the i+105^{th} light receiving element Pᵢ₊₁₀₅ serves as a center corresponding to the center feeding. Accordingly, the mid point is positioned at the center in the interval d between the i+52^{th} light receiving element Pᵢ₊₅₂ and the i+53^{th} light receiving element Pᵢ₊₅₃.

Since the i^{th} light receiving element Pᵢ and the i+105^{th} light receiving element Pᵢ₊₁₀₅ have the margins m as wide as 5 mm, respectively, five more light receiving elements are required in the left and right sides respectively to detect the permitted shift quantity of 10.5 mm in the left and right sides, respectively.

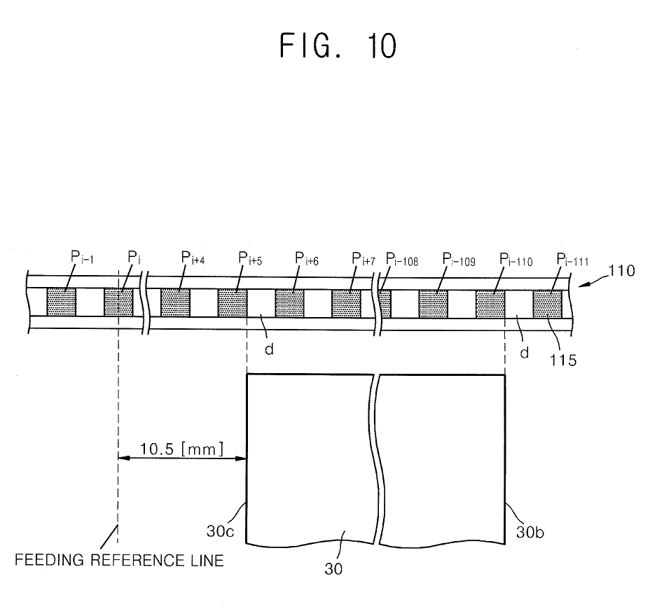

FIG. 10 illustrates the printing medium 30 being fed as it is shifted as much as the permitted shift quantity of 10.5 mm to the right from a feed reference line.

In the present exemplary embodiment, the printing medium 30 is shifted 10.5 mm right from the feeding reference line, and a line extended from the leftmost side edge 30c of printing medium 30 coincides with the right edge of the i+5^{th} light receiving element Pᵢ₊₅. Further, a line from the rightmost side edge 30b of printing media 30 is extended to the right edge of the i+110^{th} light receiving element Pᵢ₊₁₁₀.

At this time, the discriminating unit 120 of FIG. 2 senses that the printing medium 30 is shifted 10.5 mm from the feeding reference line from the output value of the respective light receiving elements 115. If the shift quantity is deviated from the permitted shift quantity, an error message is noticed by the user. In contrast, if the shift quantity is within the permitted shift quantity, as in the present exemplary embodiment, the feeding of the printing medium 30 is normally continued.

If the printing medium 30 is shifted 0.5 mm more to the right side, the shift quantity is deviated in excess of the permitted shift quantity. Because of the intervals d in the left sides of the i+5^{th} light receiving element Pᵢ₊₅ and the i+110^{th} light receiving element Pᵢ₊₁₁₀, the change of the detecting signal in a range within this interval d cannot be sensed. Therefore, it may be inferred that the detecting signal includes an error range of 1 mm.

However, the error occurred from the interval d formed between the light receiving element 115 will not cause a problem if the interval d is within a set permissible error range, for example, 1 mm. In contrast, if the interval d between the adjacent light receiving element 115 is set as zero, the error will not be produced.

Adjusting an arrangement of the feeding reference line with the medium detecting device 100 to detect the permitted shift quantity related to the produced error is also possible. That is, if the interference occurs in the light receiving elements disposed in the left and right boundaries considering the maximum shift quantity, the abnormal feeding of the printing media may be sensed through interpreting of the deviation of the printing medium 30 from the available length range.

As mentioned above, the feeding of the printing medium 30 of the format deviated from the set standard format or deviated from the permitted shift quantity can be prevented through designing the inside configuring elements of the image forming apparatus based on the permitted shift quantity. Accordingly, the pollution inside the image forming apparatus by the image forming error can be protected.

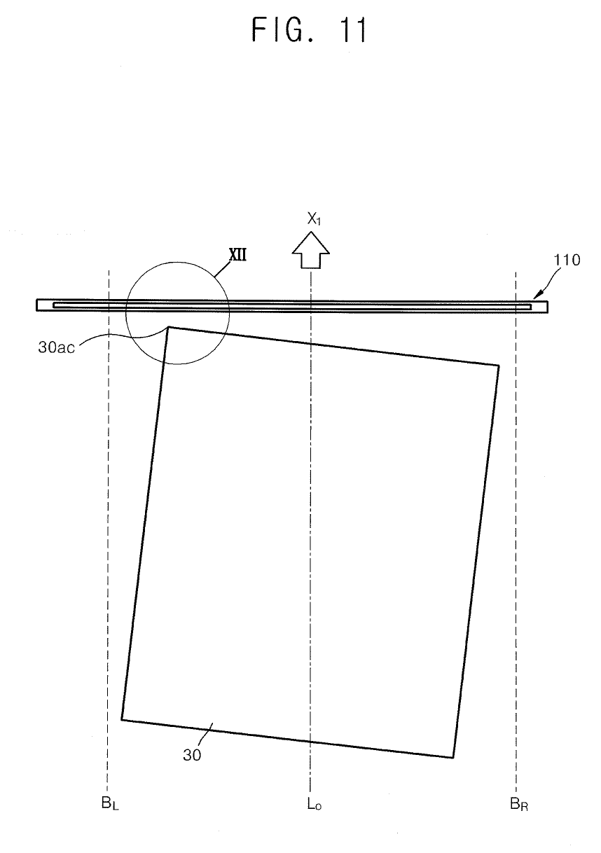

FIG. 11 is a schematic plan view illustrating the skewed printing medium 30 and an arrangement of the detecting device 110.

In the present exemplary embodiment, the image forming apparatus printing corresponding to the printing medium 30 of A4 standard format (210 mm×297 mm) transported in a lengthwise direction is represented. Accordingly, the center feeding method, the permitted shift quantity of 30% and the permitted skew quantity of ±10° are assumed.

Therefore, the print width=210 mm, shift quantity=63 mm (210×30%), available length S=print width+shift quantity=273 mm.

FIG. 11 is an example representing a feeding of the printing medium 30 when the left top corner vertex point 30ac of the printing medium 30 is deviated by 10.5 mm from the feeding reference line and is skewed 10° in the clockwise direction. As illustrated, the left bottom edge of the printing medium 30 is distanced away from the center line Lₒ and disposed adjacent to the left boundary line B_{L}. The right top edge is distanced 10.5 mm from the right boundary B_{R}.

If the printing medium 30 crosses the left boundary line B_{L}, the discriminating unit 120 senses it and sends an error message. Further, a post operation such as system stop, discharge of the printing medium 30, etc., is processed.

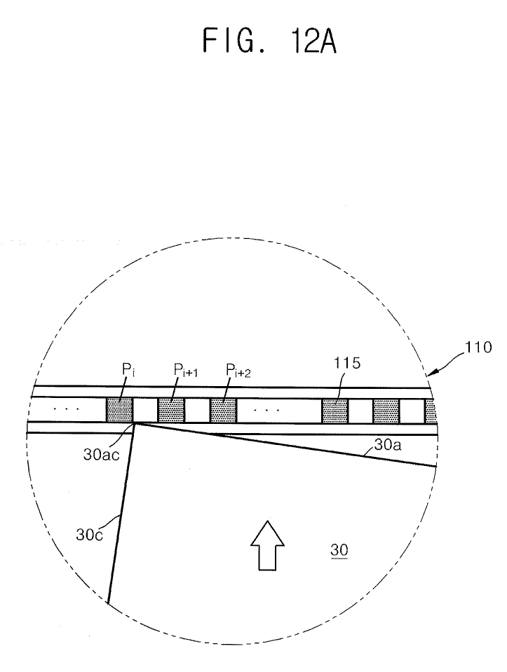

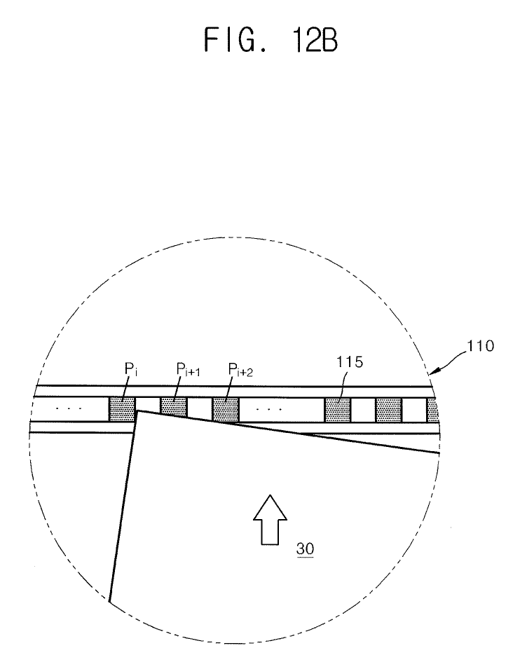

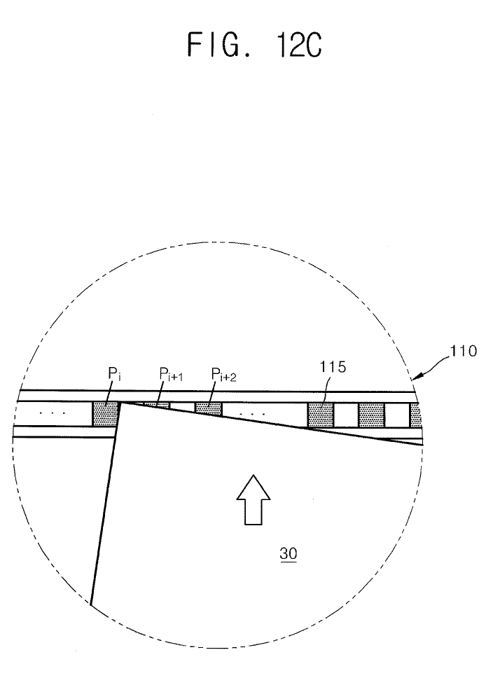

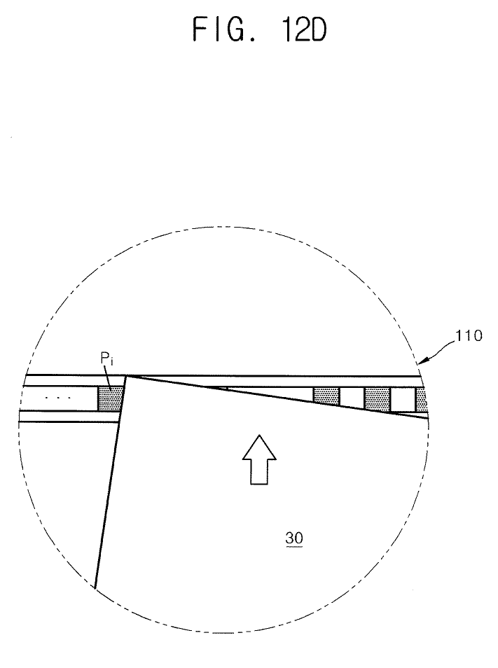

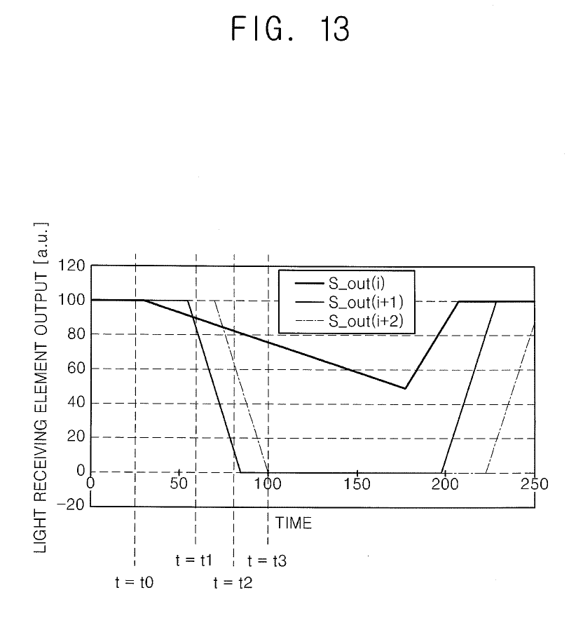

FIGS. 12A through 12D are respective enlarged views of a region XII of FIG. 11 illustrating the printing medium 30 feeding process order of the skewed and shifted printing medium 30 when it is transported. Further, FIG. 13 is a graph illustrating the light receiving element output according to a sequential change of time. In FIG. 13, S_out(i), S_out(i+1), S_out(i+2) represent the i^{th}, i+1^{th}, i+2^{th} light receiving elements Pᵢ, Pᵢ₊₁ and Pᵢ₊₂ output values, respectively.

FIG. 12A illustrates a state (t=t0) just before an entrance of the printing medium 30 so that the printing medium 30 does not cover the detecting unit 110. Thus, as illustrated in FIG. 12A and FIG. 13, every light receiving element including the i^{th}, i+1^{th}, i+2^{th} light receiving elements Pᵢ, Pᵢ₊₁ and Pᵢ₊₂ has an output value of 100.

If the feeding of the printing medium 30 starts, the discriminating unit 120 of FIG. 2 reads and stores every output value of the light receiving elements 115 to configure the detecting unit 110. Further the discriminating unit 120 periodically compares the outputs of the light receiving elements 115 with the previous values of the light receiving elements 115. If there is no difference in values through the comparison, the discriminating unit 120 can determine that the printing medium 30 has not entered into the location of the detecting unit 110.

Meanwhile, when the fed printing medium 30 starts covering a portion of the light receiving elements 115 among the plurality light receiving elements 115 at time t=t1, the output values from the covered light receiving elements 115 begin to decrease below 100%. For example, if a portion of the i+1^{th} light receiving elements Pᵢ₊₁ is covered by the printing medium 30, the output values from the i+1^{th} light receiving elements Pᵢ₊₁ become lower than the output values of the other uncovered light receiving elements.

The feeding of the printing medium 30 can be discriminated by the difference in the output values from the previously stored output values.

Also, as illustrated in FIGS. 12C and 12D during times t=t2 and t=t3, respectively, the locations and the extent of the covering are changed with the elapsed time, and the skew quantity can be determined from the change in the outputs of the light receiving elements 115, as illustrated in FIG. 13.

If examined more in detail, information related to the skew quantity can be calculated by calculating the contour form information of the printing medium 30 by mapping the output signal detected in each light receiving element 115 on the imaginary coordinate stored in the memory 121. More specifically, by setting the coordinate matched with the location of each light receiving element 115 and extracting a transition of the output value at each location in the coordinate with the elapsed time, the entire contour form information of the printing medium 30 may be confirmed and the skew quantity may be calculated.

The imaginary coordinate denotes a storing format of information on the light receiving element location, permitted print width, etc., and stores the information as the printing medium 30 contour form information in the memory 121. The imaginary coordinate is mapped with the output value of each light receiving element 115 that changes by the interference of the printing medium 30. Thus, through the mapping, the skew and the shift quantities can be determined.

If the medium detecting device 100 is configured as mentioned above, the skew and the shift quantities of the printing medium 30 fed at the location of the detecting unit 110 can be determined. This is possible under assuming that the printing medium 30 has the constant skew and shift quantities along the entire medium transport path. That is, the printing medium 30 passes an image transfer location (a position where the photosensitive body 1 and the transfer unit 6 face each other in FIG. 1) while constantly maintaining the skew and the shift quantities measured through the detecting unit 110 disposed on the medium transport path,

The printing medium 30 with the constant skew quantity may be shifted in the width direction of the medium transport path while transported from the printing medium feeding units 31, 32, or 33 to the image transfer location. Accordingly, the shift quantity of a difference in shift at the transfer location from the location of the detecting unit 110 is calculated. Also, if transported in the center feeding manner, the printing medium 30 may be skewed in a predetermined direction while transported from the printing medium feeding unit 31, 32, or 33 to the image transfer location. Accordingly, the skew quantity of a difference in skew at the transfer location from the location of the detecting unit 110 is calculated.

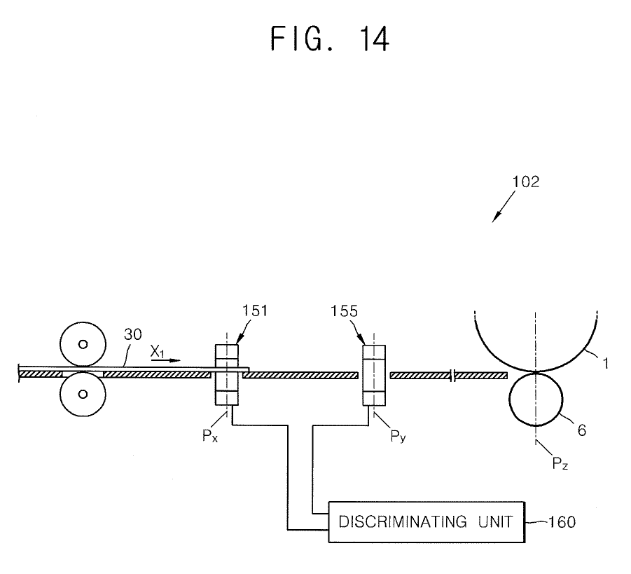

In order to meet the above conditions, printing a medium detecting device 102 according to another exemplary embodiment of the present general inventive concept may be arranged as illustrated in FIG. 14.

Referring to FIG. 14, the printing medium detecting device 102 according to another exemplary embodiment includes a first detecting unit 151 disposed at a first location Px on the medium transport path arranged along the width direction of the printing medium 30, a second detecting unit 155 disposed at a second location Py on the medium transport path arranged along the width direction of the printing medium 30, and a discriminating unit 160 to discriminate the format and the feeding position of the printing medium 30 based on data detected by the first and the second detecting units 151 and 155.

The first detecting unit 151 detects the format and the feeding position of the printing medium 30 at the first location Px. That is, the shift and the skew quantities of the printing medium 30 at the first location are detected. The second detecting unit 155 detects the feeding position of the printing medium 30 at the second location Py, which is distanced from the first location Px. A configuration and an arrangement of the first and second detecting units 151 and 155 are substantially same as the configurations and the arrangements of the medium detecting units 110 and 130 of the medium detecting devices 100 and 102 according to the embodiments of FIGS. 2 and 6A through 6E, respectively. Therefore, a detailed description thereof will be omitted.

The discriminating unit 160 determines information related to the skew and shift quantities detected respectively in the first and second locations Px and Py by the first and second detecting units 151 and 155.

If the respective skew and shift quantities are identical at two locations, it may be determined that the skew and shift quantities are maintained constant while the printing medium 30 is transported to the image transfer location, and the image appropriate to the printing medium 30 may be formed based on the above assumption.

In contrast, if the skew quantity is constant and the shift quantity is varied between the first and second locations, the shift quantity at an object location, for example, at the image transfer location Pz, can be calculated using a following equation 3 with a distance between the first location Px and the second location Py and a feeding speed of the printing medium 30.

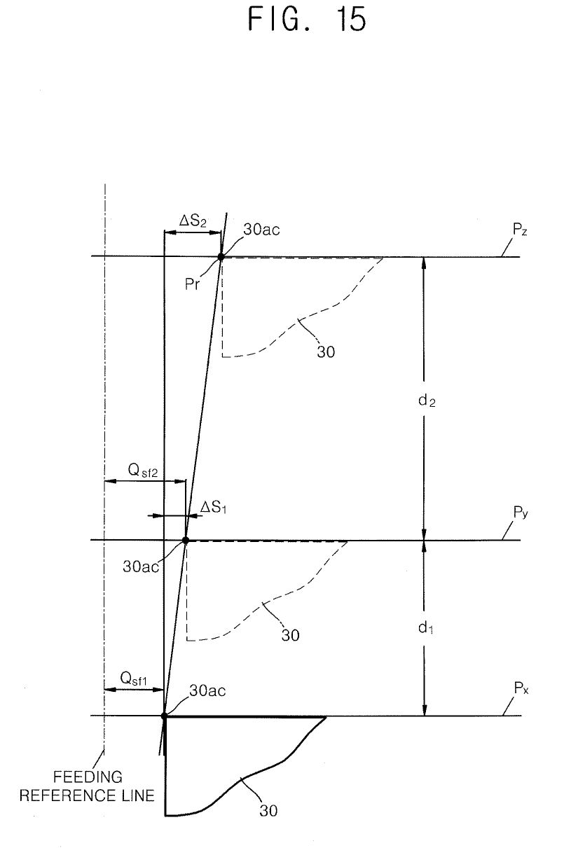

Referring to FIG. 15, ΔS₂ defined as a difference of the shift quantity at the image transfer location Pz from the shift quantity Q_{sf1} at the first location Px satisfies the equation 3.

ΔS₂=ΔS₁×(1+d₂/d₁) Equation 3

where ΔS₁ is a difference of shift quantity Q_{sf2} at the second location Py from the shift quantity Q_{sf1} at the first location Px, d₁ is a distance from the first location Px to the second location Py, and d₂ is a distance from the second location Py to the image transfer location Pz.

Accordingly, the exact shift quantity at the transfer location of the toner image can be calculated using the equation 3 if the shift quantity is linearly changed during the feeding of the printing medium 30.

In contrast, if the shift quantity is constant and the skew quantity is varied between the first and second locations, the skew quantity at the image transfer location Pz can be calculated using the following equation 4 with the distance between the first location Px and the second location Py and the feeding speed of the printing medium 30.

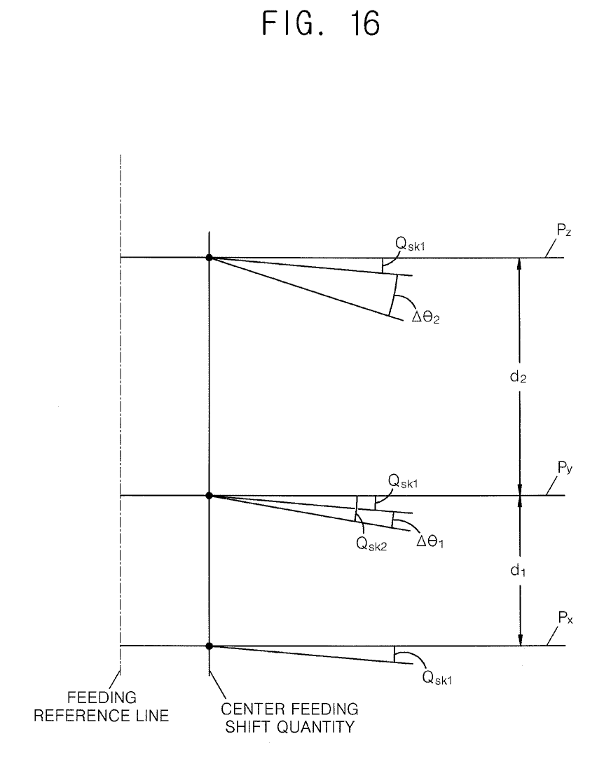

Referring to FIG. 16, Δ0₂ defined as a difference in the skew quantity between the skew quantity at the image transfer location Pz and the skew quantity Qₛₖ₁ at the first location Px satisfies the equation 4.

Δθ₂=Δθ₁×(1+d₂/d₁) Equation 4

where Δθ₂ is a difference of the skew quantity at the transfer location Pz from the skew quantity Qₛₖ₁ at the first location Px, Δθ₁ is a difference of the skew quantity Qₛₖ₂ at the second location Py from the skew quantity Qₛₖ₁ at the first location Px, d₁ is the distance from the first location Px to the second location Py, and d₂ is the distance from the second location Py to the image transfer location Pz as in equation 3.

Accordingly, the exact skew quantity at the transfer location of the toner image can be calculated using the equation 4 if the skew quantity is linearly changed during the feeding of the printing medium 30.

Also, the shift and skew quantities of the printing medium 30 can be calculated using the equations 3 and 4 when the shift and the skew quantities of the printing medium 30 linearly change together.

Although the media detecting device 102 includes the first and second detecting units 151 and 155, a configuration of three or more detecting units may be possible.

Hereinafter, a method of detecting the printing medium 30 according to the exemplary embodiment of FIG. 14 of the present general inventive concept will be described.

The method of detecting the printing medium 30 according to the exemplary embodiment of FIG. 14 of the present general inventive concept using the above-mentioned medium detecting device 102 mainly includes detecting contour form information of the fed printing medium 30 and discriminating the format and the feeding position of the fed printing medium 30 based on the detected contour form information of the printing medium 30.

The detecting of the contour form information of the fed printing medium 30 is performed through the detecting units 110, 130 and 150 with the discriminating units 120, 140 and 150 of the medium detecting device, and includes radiating the light, outputting the signal after receiving the radiated light in every predetermined time interval dependent on an existence of the fed printing medium 30, and recognizing the contour form information of the fed printing medium 30 using the output signal.

The discriminating of the format and the feeding position of the fed printing medium 30 further includes determining the format of the fed printing medium 30, the skew and shift quantities respectively. Hereinafter, the determining operation will be sectioned and examined in detail.

Determining of the fed printing medium standard format may be divided into two parts, including determining the fed printing medium standard format by detecting both the width and the length of the fed printing medium, and determining the fed printing medium standard format detecting only the width of the fed printing medium 30 with the known printing media standard formats.

A method of determining the standard format through detecting the width and the length of the fed printing medium includes calculating the width of the fed printing medium 30 with the output signal from the detecting of the fed printing medium contour form information and calculating the length of the fed printing medium 30 by an arithmetic operation with the pass time of the fed printing medium at the location of the detecting unit and the preset feeding speed of the fed printing medium. Also, the determining operation may further include storing a standard format in the memory 121 of FIG. 2 and deciding a standard format of the fed printing medium format through comparing the stored standard format with the calculated width and length of the fed printing medium 30.

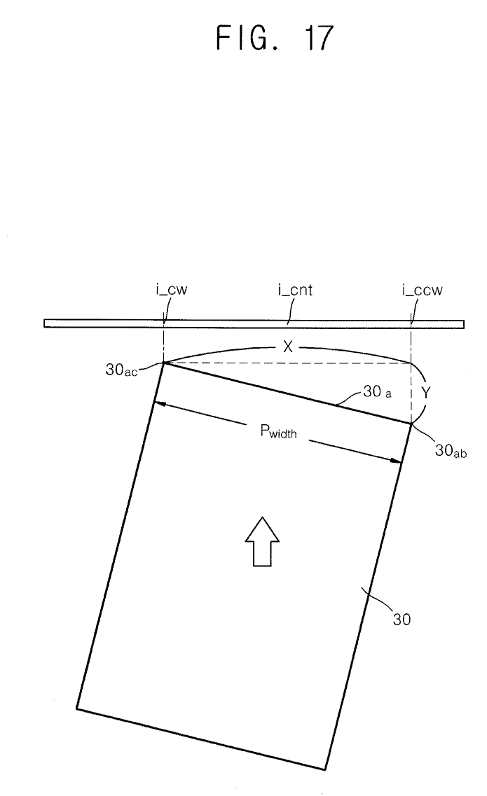

The width P_{width} of the fed printing medium 30 can be calculated from equation 5 by referring to FIG. 17.

P_{width}=sqrt(X²+Y²)

X=(i_{—}cw−i_{—}ccw)×(w+d)+m

Y=f×V×T Equation 5

where i_cw is a first index which is an index value of the light receiving element 115 disposed at a location which first meets the a corner vertex 30_{ac} of the printing medium 30 (left corner vertex as illustrated in FIG. 17) and i_ccw is a second index which is an index value of the light receiving element disposed at a location which meets an opposite other corner vertex 30_{ab} of the printing medium 30. w the width of the light receiving element, d the interval between the light receiving elements and m margin are defined same as mentioned. Accordingly, a distance X between the light receiving elements which meet the opposite corner vertices 30ac and 30ab can be calculated by multiplying the difference in the index values between the first index and the second index (i_cw−i_ccw) by the sum of the width and the interval of the light receiving element (w+d) added with the margin m.

Y is a difference in a distance in the lengthwise direction between the opposite two corner vertices 30ac and 30ab of the printing medium 30 and can be expressed by a product of a coefficient f, a feeding speed V of the fed printing medium 30 and a detecting period T of the light receiving element 115. The coefficient f denotes a number of counts counted by the counter 125 during an entering of the printing medium 30 when the corner vertex 30ac enters the detecting unit 110 until the other corner vertex 30ab enters the detecting unit 110.

In contrast, the width P_{width} of the printing medium 30 can be also calculated in case of a counterclockwise skew in the same way.

Further, information on the length of the fed printing medium 30 can be calculated by multiplying the feeding speed of the printing medium 30 with the passing time of the printing medium 30 measured through the counter 125 of FIG. 2.

A method of determining by detecting only the width of the printing medium 30 with the known standard formats includes determining a feeding direction of the printing medium 30, calculating the width of the printing medium 30 with the output signal from the detecting of the contour form information of the printing medium 30, storing the standard formats in the memory 121 and deciding the standard format of the fed printing medium 30.

The printing media 30 may be formatted in many forms by different respective international standard formats. Therefore, the information of the printing medium 30 can be determined using the standard formats if a feeding direction of the printing medium 30 by the portrait type or the landscape type is known. The portrait type refers to feeding the printing medium 30 of a rectangular shape with its shorter edge to be the width of the printing medium 30, and the landscape type refers to feeding the printing medium 30 with its longer edge to be the width of the printing medium 30.

The determining of the feeding direction of the printing medium 30 may be made by recognizing a user direction set with sensors mounted in the printing media feeding units 31, 32, and 33 of FIG. 1, through a terminal of a computer that controls the image forming apparatus.

The calculating of the width P_{width} and the length P_{length} of the printing medium 30 follows the equation 5 as mentioned above, and a detailed explanation of the calculation is not repeated.

If the information on the width P_{width} and the length P_{length} of the printing medium 30 is known, the standard format of the printing medium 30 can be determined by using a formula in table 2 expressing the standard formats with the width and the length or, using data in tables 3 through 5.

TABLE 2

| standard format | P_{width} m | P_{length} m |
|---|---|---|
| An | 2^{-1/4-n/2} | 2^{1/4-n/2} |
| Bn | 2^{-n/2} | 2^{1/2-n/2} |
| Cn | 2^{-1/8-n/2} | 2^{3/8-n/2} |

TABLE 3

| A series standard | | B series standard | | C series standard | |
|---|---|---|---|---|---|
| formats | | formats | | formats | |
| standard | | standard | | standard | |
| format | Size mm² | format | Size mm² | format | Size mm² |
| 2A0 | 1189 × 1682 | | | | |
| A0 | 841 × 1189 | B0 | 1000 × 1414 | C0 | 917 × 1297 |
| A1 | 594 × 841 | B1 | 707 × 1000 | C1 | 648 × 917 |
| A2 | 420 × 594 | B2 | 500 × 707 | C2 | 458 × 648 |
| A3 | 297 × 420 | B3 | 353 × 500 | C3 | 324 × 458 |
| A4 | 210 × 297 | B4 | 250 × 353 | C4 | 229 × 324 |
| A5 | 148 × 210 | B5 | 176 × 250 | C5 | 162 × 229 |
| A6 | 105 × 148 | B6 | 125 × 176 | C6 | 114 × 162 |
| A7 | 74 × 105 | B7 | 88 × 125 | C7 | 81 × 114 |
| A8 | 52 × 74 | B8 | 62 × 88 | C8 | 57 × 81 |
| A9 | 37 × 52 | B9 | 44 × 62 | C9 | 40 × 57 |
| A10 | 26 × 37 | B10 | 31 × 44 | C10 | 28 × 40 |

TABLE 4

| standard | | |
|---|---|---|
| format | Size mm² | contents format |
| C6 | 114 × 162 | A4 folded twice = A6 |
| DL | 110 × 220 | A4 folded twice = ⅓ A4 |
| C6/C5 | 114 × 229 | A4 folded twice = ⅓ A6 |
| C5 | 162 × 229 | A4 folded twice = A5 |
| C4 | 229 × 324 | A4 |
| C3 | 324 × 458 | A3 |
| B6 | 125 × 176 | C6 envelope |
| B5 | 176 × 250 | C5 envelope |
| B4 | 250 × 353 | C4 envelope |
| E4 | 280 × 400 | B4 |

TABLE 5

| | | | | | | | |
|---|---|---|---|---|---|---|---|
| name | Inch² | mm² | ratio | name | inch² | mm² | ratio |

| | | | | | | | |
|---|---|---|---|---|---|---|---|
| Quatro | 10 × 8 | 254 × 203 | 1.25 | Medium | 23 × 18 | 584 × 457 | 1.2778 |
| Foolscap | 13 × 8 | 330 × 203 | 1.625 | Royal | 25 × 20 | 635 × 508 | 1.25 |
| Executive, | 10½ × 7¼ | 267 × 184 | 1.4483 | Elephant | 35 × 23 | 711 × 584 | 1.2174 |
| Monarch | | | | | | | |
| Government- | 10½ × 8 | 267 × 203 | 1.3125 | Double Demy | 35 × 23½ | 889 × 597 | 1.4894 |
| Letter | | | | | | | |
| Letter | 11 × 8½ | 279 × 216 | 1.2941 | Quad Demy | 45 × 35 | 1143 × 889 | 1.2857 |
| Legal | 14 × 8½ | 356 × 216 | 1.6471 | Statement | 8½ × 5½ | 216 × 140 | 1.5455 |
| Ledger, | 17 × 11 | 432 × 279 | 1.5455 | index card | 5 × 3 | 127 × 76 | 1.667 |
| Tabloid | | | | | | | |
| Post | 19¼ × 15½ | 489 × 394 | 1.2419 | index card | 6 × 4 | 152 × 102 | 1.5 |
| Crown | 20 × 15 | 508 × 381 | 1.3333 | index card | 8 × 5 | 203 × 127 | 1.6 |
| Large Post | 21 × 16 | 533 × 419 | 1.2727 | international | 33/8 × 21/8 | 86.60 × 53.98 | 1.586 |
| | | | | business card | | | |
| Demy | 22½ × 17½ | 572 × 445 | 1.2857 | U.S. business | 3½ × 2 | 89 × 51 | 1.75 |
| | | | | card | | | |

Decidedly, the standard format of the printing medium 30 format is performed to acquire the information of the standard format of the printing media width and length by comparing the calculated width of the printing medium 30 with the standard formats of the printing media and searching a corresponding standard format length based on the information of the printing medium 30 feeding direction.

Also as illustrated in FIG. 17, the determining of the format of the fed printing medium 30 may further include deciding a corner vertex position of the corner vertex 30ac when the corner vertex 30ac of the printing medium 30 enters the interval d between the adjacent light receiving elements.

The deciding of the corner vertex position includes storing an output pattern transition of the light receiving elements according to the skew quantity, periodically storing of the output values detected in the light receiving elements, deciding the skew quantity by comparing the output values detected by the light receiving elements with the pattern stored in a lookup table, calculating a first line extended straight from the leading edge 30a of the printing medium 30 and a second line extended straight from one side edge 30b or 30c of the printing medium 30, and calculating the printing medium corner vertex position 30ab or 30ac from an intersection point of the first line and the second line.

Accuracy of the contour form information is dependent on an efficiency of the light receiving element 115. Table 6 represents different sensor pitches of the light receiving element of different resolutions and their numbers of unit sensing elements per 100 mm. As illustrated in Table 6, higher resolution narrows the sensor pitch and increases the unit sensing elements.

TABLE 6

| | sensor pitch | |
|---|---|---|
| resolution dpi | μm | N/100 mm⁻¹ |
| 600.00 | 42.3 | 2362 |
| 300.00 | 85 | 1181 |
| 150.00 | 169 | 591 |
| 75.00 | 339 | 295 |
| 37.50 | 677 | 148 |
| 18.75 | 1355 | 74 |
| 9.38 | 2709 | 37 |
| 4.69 | 5419 | 18 |
| 2.34 | 10837 | 9 |
| 1.17 | 21675 | 5 |
| 0.59 | 43349 | 2 |
| 0.29 | 86699 | 1 |
| 0.15 | 173397 | 1 |
| 0.07 | 346795 | 0 |
| 0.04 | 693589 | 0 |
| 0.02 | 1387179 | 0 |

Accordingly, relatively more accurate information on the printing medium 30 can be detected if using the light receiving element of better resolution. For example, the light receiving element of 600 dpi resolution has the sensor pitch of 42.3 μm and can measure the corner vertex 30ac or 30ab of the printing medium 30 with almost no detecting error.

Also, calculating the skew quantity is possible by comparing the output values of a table with a particular skew quantity stored in the memory. Calculating the skew quantity uses a different transition of the output values with respect to time from the light receiving elements at some particular skewing locations.

As illustrated in table 7, the value detected from the light receiving element changes according to the skew quantity. Table 7 represents a horizontal displacement calculated from the skew quantity of its length 100 mm according to one exemplary embodiment. A changing of the detected values is due to the changes in horizontal and vertical displacements.

In contrast, a value may be different from the value illustrated in table 7, depending on a method of defining the horizontal displacement.

TABLE 7

| | horizontal |
|---|---|
| skew quantity ° | displacement mm |
| 0.0 | 0.000 |
| 0.1 | 0.175 |
| 0.2 | 0.349 |
| 0.3 | 0.524 |
| 0.4 | 0.698 |
| 0.5 | 0.873 |
| 0.6 | 1.047 |
| 0.7 | 1.222 |
| 0.8 | 1.396 |
| 0.9 | 1.571 |
| 1 | 1.745 |
| 2 | 3.490 |
| 3 | 5.234 |
| 4 | 6.976 |
| 5 | 8.716 |
| 6 | 10.453 |
| 7 | 12.187 |
| 8 | 13.917 |
| 9 | 15.643 |
| 10 | 17.365 |
| 11 | 19.081 |
| 12 | 20.791 |
| 13 | 22.495 |
| 14 | 24.192 |
| 15 | 25.882 |
| 16 | 27.564 |
| 17 | 29.237 |
| 18 | 30.902 |
| 19 | 32.557 |
| 20 | 34.202 |

Therefore, the skew quantity may be obtained by comparing the detected output values with a pattern in the look up table (LUT) after storing the output pattern of the light receiving element corresponded to the skew quantity in LUT format. The skew quantity may be also obtained by comparing the increasing data of the detected values during the feeding of the printing medium 30 after storing the increased data of polling in LUT format

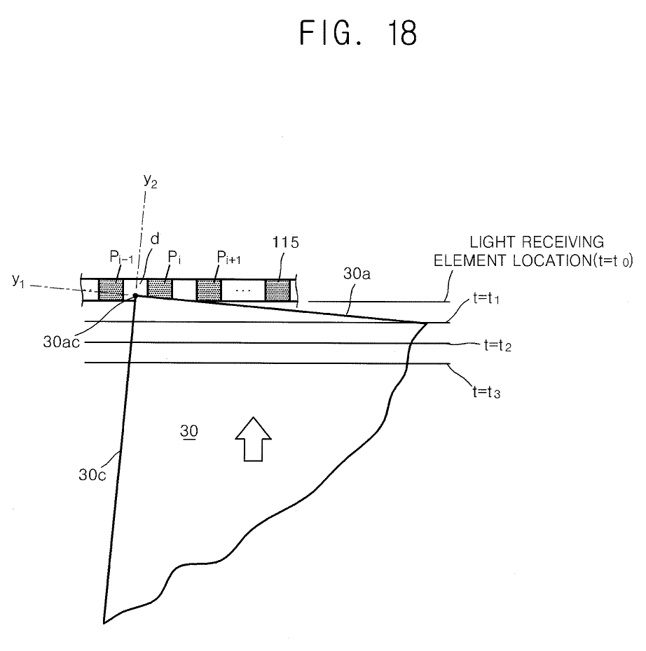

FIG. 18 is a view illustrating the corner vertex 30ac of the skewed printing medium 30 entering an interval d between the i−1^{th} and i^{th} light receiving elements 115.

Referring to FIG. 18, output values detected from the light receiving elements are stored in the memory 121 at periodic time interval, for example, t=t0, t1, t2, t3, etc. If the output value is assumed to be stored in eight bit information distinguishing 256 different values, the stored data corresponding to the output value includes contains the index number and the polling number and is extracted in ordered pair as (i, j). Accordingly, i denotes the index numbers of the light receiving elements Pᵢ₋₁, Pᵢ, etc., locations having the detected values larger than 0 and smaller than 255. The polling number is designated to allocate all detected output values from the light receiving elements by dividing in a predetermined section. Also, j is related to the polling number and the detected output values as j=polling number×sensor pitch+output value.

The first line corresponds to the front edge 30a of the printing medium 30 and the second line corresponds to the side edge 30c of the printing medium 30. As illustrated in FIG. 18, if the printing medium 30 is skewed clockwise, when viewed above from the light receiving element 115, the first line y₁ and the second line y₂ may be obtained by connecting a set of the ordered pairs (i,j) in the left side and that of the right side of the light receiving elements 115.

Also, by measuring the intersection point of the first line y1 and the second line y2, the exact position of the corner vertex 30ac of the printing medium 30 can be calculated even if the corner vertex 30ac is positioned at the interval d.

Also, the skew quantity of the printing medium 30 is possible to calculate from slopes of first and second lines y1 and y2. If the slope of the first line y1 is negative (−), the printing medium 30 is skewed in clockwise direction or if the slope is positive (+), the printing medium 30 is skewed in counterclockwise direction. Then, the detecting error from the pitch limit and the interval d between the light receiving elements 115 can be solved. The feeding position information of the printing medium 30 may correspond to a compensation in a color registration that will be described later.

Referring to FIG. 2, a method of determining the skew quantity of the printing medium 30 includes counting until two opposite corner vertexes 30ac and 30ab of the leading edge 30a are detected, deciding whether the printing medium 30 is skewed, storing the index value according to the skewing of the printing medium 30, and calculating the skew quantity.

The counting stores a count number counted by the counter 125 from the time when the entering of the printing medium 30 is first detected until the time when the opposite two corner vertices 30ac and 30ab are moved to the light receiving element 115. The deciding of whether the printing medium is skewed is dependent on which light receiving element 115 first detects the entering of the printing medium 30. When the printing medium 30 is first detected, the counter 125 is reset, the counter number is increased every time the output values detected by the light receiving elements are read, and the counter number is updated and stored in the memory 121.

The output values from the light receiving element are stored and analyzed to determine the locations of the forward vertexes of the printing medium. The first vertex location is determined to correspond to the index number of the light receiving element first detecting interference of the printing medium 30. As the printing medium first crosses the light receiving unit 115, if more than one light receiving element together first detect interference of the printing medium 30 (e.g., at t=t0), the first vertex location is determined to correspond to the index number of the light receiving element farthest away from the center index i_cnt. The second vertex location is determined to correspond to the index number first detecting a transition from interference to no interference (when it is determined that skew exists).

More specifically, an index number of the light receiving element 115 that changes its output value is confirmed and compared with a center index (i_cnt) of the light receiving element 115 when the printing medium 30 is initially detected (at this point, the counter 125 number counted in the counter has been previously reset to 0). If at this time the center index (i_cnt) also has a change in its output value indicating interference of the printing medium 30, it is determined that there is no skew. Otherwise, if the detected index value is smaller than the center index (i_cnt), the skew is a left side skew (clockwise rotation) and the output values of the light receiving elements 115 are stored in the first index (i_cw). On the other hand, if the detected index value is larger than the center index (i_cnt), the skew is a right side skew (counterclockwise rotation) and the output values of the light receiving elements 115 are stored in the second index (i_ccw). Here, during a clockwise skew as illustrated in FIG. 18, the counter number counted by the counter 125 is increased after the printing medium 30 is first detected after the printing medium 30 is first detected and ceases to be increased after detecting that the right corner vertex (30ab of FIG. 17) has passed the light receiving elements 115. Then, the position of the right corner vertex 30ab may be determined from the vertex number of the right vertex (corresponding to its horizontal position in FIG. 17) and from the counter number held in the counter (corresponding to its vertical position in FIG. 17).

Further, the calculating the skew quantity calculates the skew quantity through the counter number and the values stored in the first and the second indexes (i_cw) and (i_ccw). Accordingly, the skew quantity may satisfy equation 6.

Skew quantity=arctan(Y/X) Equation 6

where X and Y follow the definition according to Equation 5.

The printing medium 30 may be changed in its skew quantity while being fed from the printing medium feed unit 31, 32 and 33 to the target location (image transfer location). So, the skew quantity at the transfer location is required to be calculated from the measured skew quantity at the location of the detecting unit 110.

A method of determining the skew quantity further includes discerning whether the skew quantity is changed while the printing medium 30 is being transported, and calculating the skew quantity at the target location (for example, the transfer location) if the skew quantity changes.

The discerning of the skew quantity change is examined by referring to FIGS. 14 and 16. First, the respective skew quantities of the fed printing medium 30 are calculated by the first and second detecting units 151 and 155 arranged at Px and Py along the media transport path 20 of the printing medium 30. The first and the second detecting units 151 and 155 include the plurality of light receiving elements 115 arranged in the width direction of the printing medium 30. Then, the change of the skew quantity is decided by comparing the skew quantities detected in the first and second detecting units 151 and 155.

If the change is discerned, the skew quantity at the target location can be calculated by using Equation 4.

Determining of the shift quantity assumes the leading edge 30a of the printing medium 30 as a reference when the printing medium 30 is shifted and skewed while being fed.

Referring to FIG. 2, deciding whether the detecting of the printing medium 30 is started, storing the output values from the light receiving elements 115 which are correspondent to the left and right top boundary locations of the printing medium 30, respectively, and calculating the shift quantity of the printing medium 30 are included.

The deciding of the start of the detecting decides which light receiving elements among the plurality of light receiving elements 115 respectively detect the left and right top ends of the leading edge 30a of the fed printing medium 30. Further, the storing of the output values stores the output values from the light receiving elements 115 corresponding to the top left and right boundary locations of the printing medium 30 in the first and second indexes (i_cw) and (i_ccw).

Also, the calculating of the skew quantity compares the values stored in the first and second indexes (i_cw) and (i_ccw) and calculates the shift quantity at the detecting location. The calculated shift quantity may satisfy a following equation (7).

shift quantity=[(i_{—}cw+i_{—}ccw)/2−i_{—}cnt]×(w+d)+m Equation 7

where w, d and m are defined in equation 5. If the shift quantity from equation 7 is negative, the left shift of the printing medium 30 and if the shift quantity from equation 7 is positive, which results in a right shift of the printing medium 30.

Meanwhile, the shift quantity may be changed in the media transport path width direction while the printing medium 30 is being transported from the printing media feed unit 31, 32 or 33 to the target location (image transfer location). Then, the shift quantity at the transfer location is required to be calculated from the measured shift quantity at the location of the detecting unit 110.

A method of determining the shift quantity further includes discerning whether the shift quantity is changed while the printing medium 30 is being transported, and calculating the shift quantity at the target location (for example, the transfer location) if the shift quantity changes.

Referring to FIGS. 14 and 15, the discerning of the shift quantity change is examined. First, the respective shift quantities of the fed printing medium 30 are calculated through the first and second detecting units 151 and 155 arranged at Px and Py along the media transport path 20 of the printing medium 30. The first and the second detecting units 151 and 155 include the plurality of light receiving elements 115 arranged in the width direction of the printing medium 30. Accordingly, the change of the shift quantity is discerned by comparing the shift quantities detected in the first and second detecting units 151 and 155.

If the change of the shift quantity is discerned, the shift quantity at the target location can be calculated by using Equation 3.

A method of detecting the printing medium 30 according to the configuration of the present general inventive concept acquires the contour form information of the printing medium through the detecting unit and determines the format, the skew quantity and the shift quantity. Also, even if the corner vertex of the leading edge enters the interval between the light receiving element 115, an exact position of the corner vertex of the leading edge can be calculated.

Further, even if at least one or more than one of the shift quantity and the skew quantity changes during the printing medium transport, the correct shift and skew quantities at the target location can be calculated by measuring the quantities at different locations.

Hereinafter, by using the position information of the printing medium 30 detected in the above mentioned method, the image forming apparatus which outputs the printing medium 30 optimized the developed image on the photosensitive body and a method of outputting the image of the image forming apparatus will be explained in detail.

Referring to FIG. 1, the image forming apparatus according to an exemplary embodiment of the present general inventive concept includes printing medium feed units 31, 32 and 33, the image forming unit 10, and the medium detecting device 100.

The image forming unit 10 forms an image on the fed printing medium 30 by an electro-photographic method or ink-jet head method.

FIG. 1 illustrates the image forming unit 10 of the electro-photographic method, and includes the photosensitive body 1, the charger 2, the exposure unit 3, the development unit 5 to develop the toner image corresponding to the electro-static latent image, the transfer unit 6 to transfer the developed toner image to the printing medium 30 and the fusing unit 8 to fuse the transferred toner image on the printing medium 30.

The medium detecting device 100 disposed on the media transport path detects the contour form information of the fed printing media 30 and determines the format and the feeding position of the printing medium 30 based on the detected contour form information. The medium detecting device 100 is substantially the same as the medium detecting device described above, so a detailed description thereof is omitted.

Also, referring to FIG. 2, the image forming apparatus according to an embodiment of the present general inventive concept may further include an image compensating unit 200 and a user interface (UI) unit 300. The image compensating unit 200 compensates an image forming error through feedback of the contour form information of the fed printing medium 30 detected by the medium detecting device 100. Further, the UI unit 300 informs a user the information of the printing medium 30 detected by the discriminating unit 120. Further, the UI unit may include, for example, a software operating in the host computer, a display provided in the image forming apparatus, and an alarm.

Referring to FIGS. 1 and 2, a method of image outputting of the image forming apparatus according to an exemplary embodiment of the present general inventive concept includes detecting the contour form information of the fed printing medium 30, determining the format and the feeding position of the printing medium 30 and compensating the image forming error through feedback the determined format and the feeding position of the printing medium 30 to the image forming unit 10.

The detecting of the contour form information and the determining of the format and the position is substantially the same as the media detecting method described above, so a detailed description thereof is omitted.

The compensating of the image form error compensates the image based on the contour form information, such as the format of the printing medium 30, the skew quantity, and the shift quantity. The image compensation is performed by compensating an image signal contained in a light beam scanning the photosensitive body 1 through the exposure unit 3. If described in more detail, the image signal contained in a scanned line is generated by line unit and output in correspondence with the skew and shift quantities of the printing medium 30. More specifically, the image may be compensated by scanning the light beam by controlling the exposure unit 3 to skew the image signal as much as the skew quantity when the printing medium 30 is skewed when forming the electro-static latent image on the photosensitive body 1 corresponding to the image that will be transferred to the printing medium 30. Also, if the printing medium is shifted to one side, the shift quantity may be compensated by adjusting start and end line scanning times of the light beam.

The shift quantity may also be compensated by adjusting start and end ink-jetting times the ink-jet head which is installed in a carriage that has reciprocating motion. Accordingly, the poor printing from the loss of the image may be prevented in the shifted fed printing medium 30 by adjusting the start and end printing times.

A method of image outputting may further include determining whether a format of the printing medium 30 corresponds with the user set printing medium standard format, and notifying the incompatibility to a user if the format dose not correspond to the preset standard format.

The deciding of the correspondence of the fed printing medium format acquires the information of the printing medium 30 loaded in the medium feed units 31, 32 and 33 necessary to decide whether the printing medium format corresponds with set printing medium standard formats set by a user. If the formats do not correspond to each other, a notification is set through the UI unit 300. Then, a user may check and load the printing medium 30 on the medium feed units 31, 32 and 33 corresponding to the set standard format size to correspond to the image size.

Also, the determining of the format correspondence may determine whether there is any other cartridge in the printing medium feed units 31, 32 or 33 that is loaded with the size corresponding to the image size before notifying the non-correspondence to a user through the UI unit 300. If it is decided that the corresponding printing medium exists, the correspondent printing medium 30 may be fed without notifying a user. If the corresponding printing medium 30 cannot be found in any cartridge after repeating the same process, the discriminating unit 120 notifies a user through the UI unit 300.

Also, if the skew or the shift quantity of the printing medium 30 deviates from the permitted value, the image forming apparatus pauses printing and discharges the printing medium 30 through the discharge roller 42 of FIG. 1. Further, the new printing medium 30 may be fed from the printing medium feeding unit 31, 32 or 33, and the image may be reprinted on a page that has been paused. The message requiring to check the load state of the printing medium may be displayed through the UI unit 300.

The image forming apparatus configured as mentioned above according to an embodiment of the present general inventive concept acquires the contour form information of the printing medium 30, includes the media detecting device 100 to detect the format, the skew quantity and the shift quantity of the printing medium 30, and may form the image on a right position.

Accordingly, forming of the image deviated from the printing medium 30 can be prevented even if the printing medium format is not matched. Also, the image may be formed on the desired location of the printing medium 30 by compensating in forming the image on the photosensitive body 1 with the corresponding quantity even if the printing medium 30 is skewed or shifted during the printing process.

Hereinafter, a color image forming apparatus of configuration that can compensate a color registration according to an exemplary embodiment of the present general inventive concept, a color registration device in the color image forming apparatus, and a color registration method will be explained.

The color image forming apparatus using the electrophotographic method according to an exemplary embodiment of the present general inventive concept is an apparatus which forms a full color image by overlapping an image of mono color with an image of different mono colors and requires a registration of aligning the overlapped mono color images with each other. A compensating unit that performs color registration is included in the color registration device.

Before examining the electrophotographic color image forming apparatus, a conventional color image forming apparatus will be described.

An electrophotographic image forming apparatus may be classified either to a multi-pass type and a single pass type depending on a number of image forming processes which form the color image on one printing medium 30.

The multi-pass type image forming apparatus is equipped with development units of different respective colors which are independently used, and a scanning unit and photosensitive body which are commonly used, thereby having an advantage of compactness. In contrast, an image forming process has to be performed by aligning each color overlapped during color printing, and may be slow in printing compared to the single color printing.

The multi-pass type electro-photographic color image forming apparatus determines a color image by equipping one photosensitive body with one light scanning unit. Thus, ends aligned in a main scanning direction of the scan line that scans the photosensitive body by respective colors agree with each other without an additional adjustment, and a reference line is provided to perform the ends alignment in a sub scanning direction of the scan line on the photosensitive body. While performing development processes of respective colors, the sub scanning direction is aligned by forming the latent image by scanning the light beam based on the reference line.

Thus, the multi-pass type electrophotographic color image forming apparatus can align a registration through forming by each color development unit and overlapping on the transfer unit by sequentially transferring each color image without any separate compensation corresponding to color registration.

Meanwhile, the single pass type electrophotographic color image forming apparatus has a configuration that forms a color image on the one printing medium 30 during every revolution of the photosensitive body and has difficulty in the color registration. A single pass type electrophotographic color forming apparatus, and a device and method of the color registration will be explained in detail.

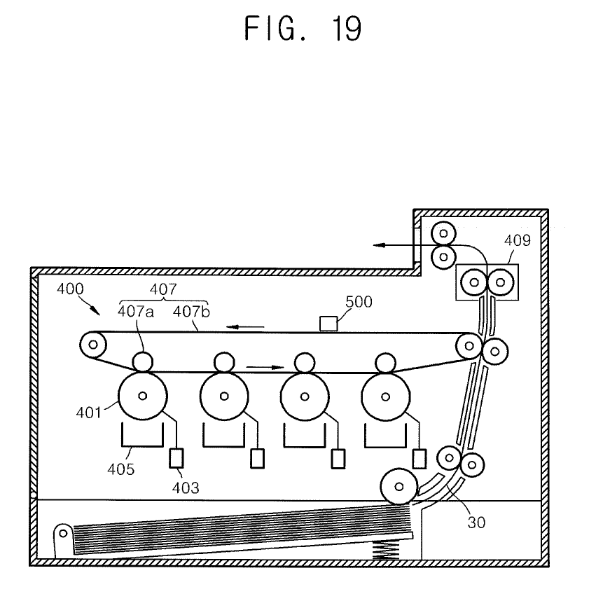

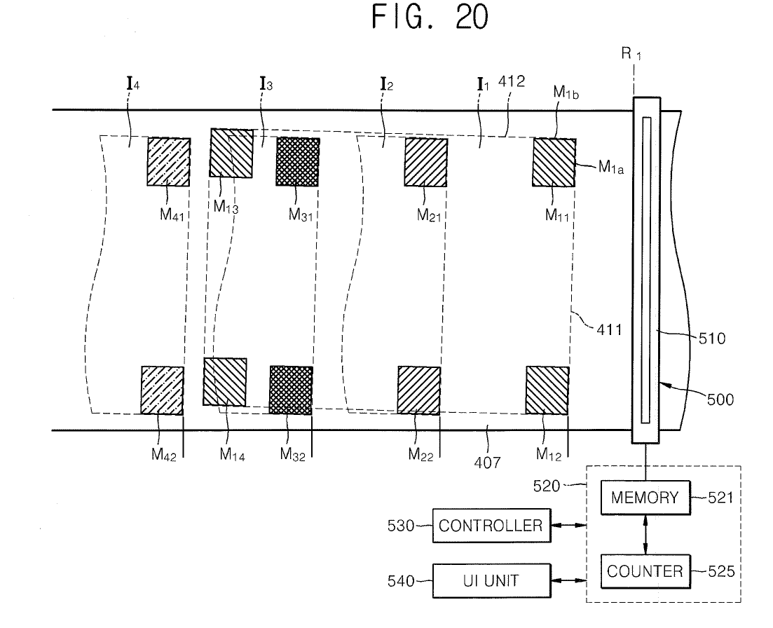

FIG. 19 is a schematic view illustrating a single path type electro-photographic color image forming apparatus according to an exemplary embodiment of the present general inventive concept. Further, FIG. 20 is a view illustrating test patterns corresponding to respective colors on an image transfer path according to the exemplary embodiment of FIG. 2 of the present general inventive concept.

Referring to FIG. 19, the color image forming apparatus according to an exemplary embodiment of the present general inventive concept independently forms predetermined images corresponding to respective colors, overlaps the images of respective colors to form a color image, and includes an image forming unit 400 and a color registration device 500.

The image forming unit 400 forms the color image to the fed printing medium 30 and test patterns (M₁₁, . . . , M₄₂) of corresponding respective colors proportional to the formats of the printing medium 30 on the image transfer path (for example, transfer unit 407 of a belt type as illustrated in FIG. 19)

Accordingly, the image forming unit 400 includes a photosensitive body 401, an exposure unit 403 to form a latent image by scanning a light to the photosensitive body 401, a development unit 405 to form an image through developing a toner on the latent image on the photosensitive body 401, a transfer unit 407 to transfer the toner image developed on the photosensitive body 401 to the printing medium 30, a fusing unit 409 that heats and presses to fuse the image transferred to the printing medium 30, and a color registration device 500.

The development unit 405 disposed to face the photosensitive body 401 develops the toner on a region where the latent image on the photosensitive body 401 is formed. The development unit 405 and the photosensitive body 401 are provided to correspond to each color to form a full color image in the single pass configuration. FIG. 19 illustrates an example of a configuration of the four development units 405 and four photosensitive bodies 401 to implement four colors, yellow, magenta, cyan and black.

The respective exposure units 403 scan the light beam to form the latent images on the respective photosensitive bodies 401. Accordingly, the exposure units 403 have a multi light beam configuration in order to scan the light beam simultaneously on the plural photosensitive bodies 401.

The transfer unit 407 is arranged to face the photosensitive body 401 by disposing the printing medium 30 fed along the media transport path therebetween, and transfers the toner image formed on the photosensitive body 401 to the printing medium 30. Then, the transferred image on the printing medium 30 is fused by the fuse unit 409.

Though not illustrated in FIG. 19, the single pass color image forming apparatus includes a charger at locations corresponding to the plurality of photosensitive bodies 401 to charge the photosensitive bodies 401 to a predetermined electric potential, an eraser to remove a residual charge remained on the photosensitive bodies 401, and a cleaning unit to remove a material adhered on the photosensitive bodies 401.

The single pass electrophotographic color image forming apparatus configured as mentioned above sequentially transfers and overlaps the toner images formed on the respective photosensitive bodies 401 of each color to the printing medium 30, which is fed between the photosensitive bodies 401 and the transfer unit 407

Since the light beams are respectively scanned on the plurality of photosensitive bodies 401, it is difficult to implement the full color image by overlapping the color images transferred on the printing medium 30 at a correct location. This difficulty is produced from a tolerance in assembling components to form the image such as the photosensitive body 401, the exposure unit 403 and the transfer unit 407, and a difference in a set signal between each exposure unit 403 corresponding to a reference position.

For example, in order to form an overlapped image of first and second colors by sequentially transferring an image of the first color and an image of the second color to the printing medium 30, the front end position of the main scanning direction of the first color image and the second color image may not correspond with each other due to the assembling tolerance of the components and a difference in a scanning start time between each scanning light beam, even if the image forming apparatus is designed to accord the front end position of the main scanning direction of the first color image with the second color image. Also, a disaccord of the image in the sub scanning direction may be produced due to the assembling tolerance if a reference position of an alignment in the sub scanning direction is set corresponding to each of the plurality of photosensitive bodies 401.

The disaccord of the image is called mis-registration and causes the poor printing.

The color registration device 500 is provided to overcome a problem from the mis-registration and to compensate a color registration by detecting color registration information from contour form information of each color image.

The color registration device 500 installed adjacent to the transfer unit 407 acquires a formation information corresponding to each color test pattern that will be mentioned.

Here, the transfer unit 407 includes a plurality transfer support rollers 407a disposed opposite to each photosensitive body 401 and a transfer belt 407b that winds the transfer support roller 407a and backs-up a transfer of the printing medium 30 and the color image. The transfer belt 407b charges the printing medium 30 to a predetermined electrical potential so that the respective images formed on the plurality of photosensitive bodies 401 may be sequentially transferred to the fed printing medium 30.

Each color test pattern formed on the photosensitive body 401 by the exposure unit 403 of each color is transferred to the transfer belt 407b.

If the image forming apparatus is configured as illustrated in FIG. 19, the test pattern includes a first through a fourth test pattern (M₁₁, M₁₂)(M₂₁, M₂₂)(M₃₁, M₃₂)(M₄₁, M₄₂) divided by each color. The first through the fourth test patterns (M₁₁, M₁₂)(M₂₁, M₂₂)(M₃₁, M₃₂) and (M₄₁, M₄₂) are separated by a predetermined distance from each other.

Also, with respect to an image region (I₁, I₂, I₃, I₄) as a reference where the toner image is formed, the respective first through fourth test patterns (M₁₁, M₁₂)(M₂₁, M₂₂)(M₃₁, M₃₂) (M₄₁, M₄₂) are formed on predetermined regions including opposite side edges of front and end edges of the image region.

As illustrated in FIG. 20, the image region I₁ corresponding to a region of the printing medium 30 where a predetermined color image is formed includes front edge part 411 and a pair of side edge parts 412. Two patterns M₁₁, M₁₂ included in the first test pattern are respectively disposed at two opposite side edges close to the front edge part 411. That is, a front end edge M₁ₐ and a side end edge M_{1b} of the first patterns M₁₁ and M₁₂ accord with the front edge part 411 and the side edge part 412 of the image region I₁. A width and position (the skew quantity, the shift quantity) of the image region I₁ can be determined if the contour form information of the first test patterns M₁₁, M₁₂ is read.

In order to determine a length of the image region I₁, the first test pattern may further include two more test patterns (M₁₃, M₁₄) at parts corresponding to side edges 412, which are close to a side portion of its back edge. Then, an accordance of image data with the image region to be formed with the image may be determined by acquiring the entire contour form image information of image region I₁ through the four test patterns.

Respective relations between the second through fourth test pattern (M₂₁, M₂₂)(M₃₁, M₃₂)(M₄₁, M₄₂) and their corresponding image regions (I₂, I₃, I₄) are similar to relations between the first test pattern (M₁₁, M₁₂) and its corresponding image region I₁, so a detailed explanation thereof will not be repeated.

As illustrated in FIG. 20, a size of the first through fourth test pattern (M₁₁, M₁₂)(M₂₁, M₂₂)(M₃₁, M₃₂) and (M₄₁, M₄₂) is determined in consideration of a resolution of a detecting unit 510 that will be mentioned. In other words, the test pattern size corresponding to a detecting unit 510 of a higher resolution may be formed relatively smaller compared to a detecting unit 510 of a lower resolution.

The color registration device 500 according to an exemplary embodiment of the present general inventive concept is disposed on the transfer belt 407b and includes the detecting unit 510 that detects the contour form and position information of the first through fourth test patterns (M₁₁, M₁₂)(M₂₁, M₂₂)(M₃₁, M₃₂) and (M₄₁, M₄₂), a discriminating unit 520 that determines whether the mis-registration occurs based on the detected data from the detecting unit 510 and a controller 530 that compensates the color registration.

The detecting unit 510 is arranged at a predetermined location of the transfer belt 407b in a width direction of the transfer belt 407b where the first through fourth test pattern (M₁₁, M₁₂)(M₂₁, M₂₂)(M₃₁, M₃₂) and (M₄₁, M₄₂) information can be detected.

Accordingly, the detecting unit 510 sequentially detects basic information required in the color registration including the size of the first through fourth test pattern (M₁₁, M₁₂)(M₂₁, M₂₂)(M₃₁, M₃₂) and (M₄₁, M₄₂) formed on the transfer belt 407b, the shift quantity and the skew quantity.

The detail configuration of the detecting unit 510 is similar to the media detecting device 100 and 102 to detect the printing medium 30 according to previous exemplary embodiments of the present general inventive concept, so a detailed description thereof will be omitted.

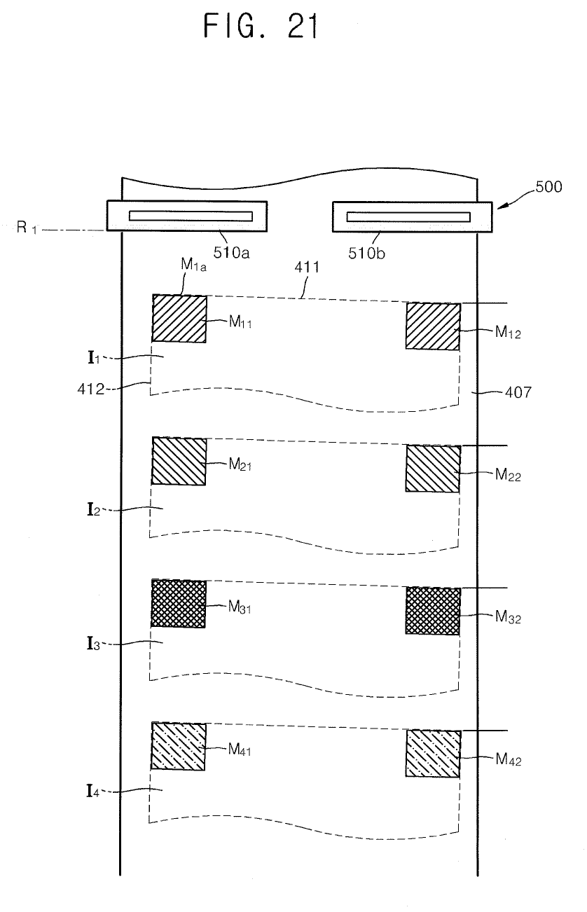

However, the detecting unit 510 is not restricted in its configuration to be disposed across an entire width of the image transfer path, but may be configured as illustrated in FIG. 21.

Referring to FIG. 21, the detecting unit 510 includes first and second detecting units 510a and 510b separately formed on the image transfer path to correspond to the separated test pattern. The first detecting unit 510a is installed around one side edge of the transfer belt 407b and detects information of the test patterns (M₁₁, M₂₁, M₃₁, M₄₁) in the first through fourth test patterns formed on the left top parts of the image region (I₁, I₂, I₃, I₄). Further, the detecting unit 510b is installed around the other side edge of the transfer belt 407b and detects information of the test patterns (M₁₂, M₂₂, M₃₂, M₄₂) in the first through fourth test pattern formed on the right top parts of the image region (I₁, I₂, I₃, I₄).

As illustrated in FIG. 20, the discriminating unit 520 includes a memory 521 and a counter 525, and calculates the front edge positions, the shift quantity, the skew quantity and the size of the first through fourth test pattern (M₁₁, M₁₂)(M₂₁, M₂₂)(M₃₁, M₃₂) and (M₄₁, M₄₂) after analyzing the sequentially detected first through fourth test pattern (M₁₁, M₁₂)(M₂₁, M₂₂)(M₃₁, M₃₂) and (M₄₁, M₄₂). The calculating method is similar to the calculating method explained previously with reference to the media detecting device 100, and a detailed explanation thereof will be omitted.

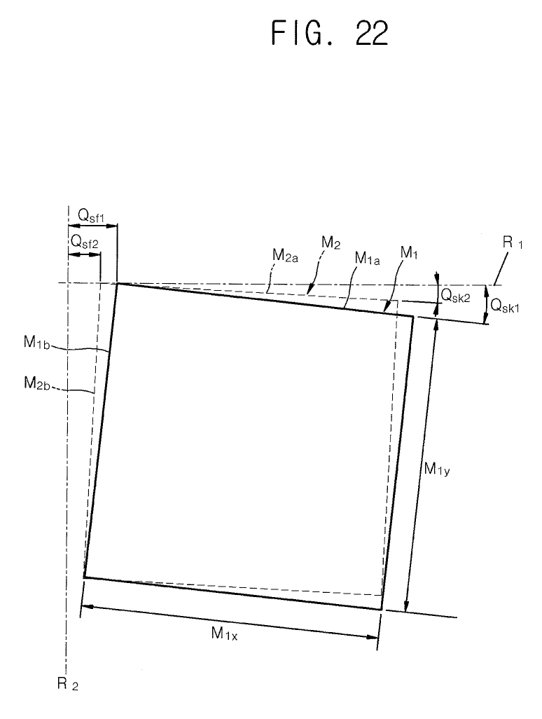

Also, an interval between the first through fourth test pattern (M₁₁, M₁₂)(M₂₁, M₂₂)(M₃₁, M₃₂) and (M₄₁, M₄₂) is set by a predetermined value and is used to evaluate a distance error in the sub scanning direction. That is, the interval between the first through fourth test patterns (M₁₁, M₁₂)(M₂₁, M₂₂)(M₃₁, M₃₂) and (M₄₁, M₄₂) set by the predetermined value is compared with the measured results of the first through fourth test patterns (M₁₁, M₁₂)(M₂₁, M₂₂)(M₃₁, M₃₂) and (M₄₁, M₄₂) by the detecting unit 510. A detail related to this will be examined referring to FIG. 22.

FIG. 22 illustrates an overlapping of the first test pattern M₁ with the second test pattern M₂ with the first test pattern as a reference in consideration of a moving velocity of the transfer belt 407b. This is to imitate the full color image formed by overlapping with the color images of different colors.

Referring to FIG. 22, a first and a second reference lines R₁ and R₂ are imaginary lines matched with the front edge and the left side edge of the test pattern in an ideal case. The skew and shift quantities are calculated based on the first and second reference lines R₁ and R₂.

Also, when based on the first and second reference lines R₁ and R₂, FIG. 22 illustrates that the first test pattern M₁ has the skew quantity Qₛₖ₁ (an angle between the top edge M₁ₐ and the first reference line R₁) and the shift quantity Q_{sf1} (a gap between a corner vertex made by the top edge M₁ₐ and the side edge M_{1b} and the second reference line R₂), while the second test pattern M₂ has the skew quantity Qₛₖ₂ (an angle between the top edge M₂ₐ and the first reference line R₁) and the shift quantity Q_{sf2} (a gap between a corner vertex made by the top edge M₂ₐ and the side edge M_{2b} and the second reference line R₂). Also, the size of the first test pattern M₁, width M₁ₓ and length M_{1y} can be measured.

Then, the color registration between the first and the second test patterns, M₁ and M₂ can be compensated by according the first and the second test patterns M₁ and M₂ considering the skew quantities Qₛₖ₁ and Qₛₖ₂, and the shift Q_{sf1} and Q_{sf2} quantities through adjusting the light scanning time of each color related to an amount of the error in the controller 530.

The controller 530 recognizes an image of overlapped with each color to be transferred based on the first through fourth test patterns (M₁₁, M₁₂)(M₂₁, M₂₂)(M₃₁, M₃₂) and (M₄₁, M₄₂). Further, an error in the front edge position of main and/or sub scanning direction between different colors, magnification of each color image, the skew and the shift quantities are estimated. Then, based on these estimated values, parameters that control the development units 405 and the light scanning units of respective colors, such as horizontal and vertical synchronized signals, the shift quantity are reset in order to accord the first through fourth test patterns (M₁₁, M₁₂)(M₂₁, M₂₂)(M₃₁, M₃₂) and (M₄₁, M₄₂).

Here, the adjustment of the first through fourth test patterns (M₁₁, M₁₂)(M₂₁, M₂₂)(M₃₁, M₃₂) and (M₄₁, M₄₂) may be made by adjusting the other test patterns based on one test pattern or adjusting the first through fourth test patterns (M₁₁, M₁₂)(M₂₁, M₂₂)(M₃₁, M₃₂) and (M₄₁, M₄₂) based on an arbitrary reference (design) value. The color registration of each color can be compensated through resetting parameters necessary to form the image as mentioned.

The color image forming apparatus may further include a user interface (UI) device 540. The UI device displays information to a user regarding the color registration determined by the discriminating unit 520.

Hereinafter, a method of color registration in the color image forming apparatus will be explained in detail.

Referring to FIGS. 19 and 22, the method of color registration of the color image forming apparatus according to an exemplary embodiment of the present general inventive concept includes forming the test patterns (M₁₁, M₁₂)(M₂₁, M₂₂)(M₃₁, M₃₂) and (M₄₁, M₄₂) corresponding to the respective colors proportional to the size of the fed printing medium 30 which is the transferring object on the image transfer path, detecting the contour form information on the test patterns (M₁₁, M₁₂)(M₂₁, M₂₂)(M₃₁, M₃₂) and (M₄₁, M₄₂) corresponding to respective colors, determining whether the mis-registration occurs based on the data detected in the detecting unit 510, and compensating the mis-registration.

Since the detecting of the contour form information on the test patterns (M₁₁, M₁₂)(M₂₁, M₂₂)(M₃₁, M₃₂) and (M₄₁, M₄₂) and the detecting of the printing medium contour information are similar, a detailed explanation thereof will be omitted.

The determining of whether the mis-registration occurs is performed based on an accordance of respective values of a format between the contour form information, the skew quantity and the shift quantity by comparing the respective values.

The compensating of the mis-registration is performed based on the contour form information of the test patterns (M₁₁, M₁₂)(M₂₁, M₂₂)(M₃₁, M₃₂) and (M₄₁, M₄₂), such as the size of the patterns dependent on the format of the printing medium 30, the skew quantity, and the shift quantity. The compensation of the mis-registration is performed by an image signal included in the light beam that scans the photosensitive body 401 through the exposure unit 403 of FIG. 8. Particularly, the image signals of the respective colors included in the scanning line scanned in line basis through the exposure unit 403 are produced to correspond with the skew and shift quantities of the test patterns (M₁₁, M₁₂)(M₂₁, M₂₂)(M₃₁, M₃₂) and (M₄₁, M₄₂). That is, the compensation is accomplished by beaming the light through controlling the respective image signals to be shifted and skewed in correspondence with the skew and shift quantities of the respective colors when forming the latent images of the respective colors.

The method of color registration of the present information may further include informing a user of the color registration information.

The image forming apparatus of the configuration as mentioned above according to an embodiment of the present general inventive concept includes the media detecting device that acquires the contour form information of the fed printing medium 30 and correctly measures the format of the printing medium 30, the skew quantity and the shift quantity and forms an image at the correct position on the printing medium 30.

Accordingly, a forming of the image deviated from the printing medium 30 may be prevented even if the format of the printing medium 30 is inappropriate. Also, the image may be formed on the desired position of the printing medium 30 by forming the image on the photosensitive body by compensating as much as the corresponding values of the skew and shift quantities even if the printing medium 30 is skewed and shifted.

A media detecting device and a method of detecting the media thereof can determine a format, a skew quantity and a shift quantity of the printing medium by acquiring contour form information of the printing medium by a detecting unit disposed on a medium transport path. A corner vertex of the printing medium leading edge can be also precisely calculated even though the corner vertex of the printing medium enters the interval between light receiving elements. Correct values of the skew and shift quantities at a target location can be calculated through measuring changes of least one of the skew and the shift quantities during transporting of the printing medium.

The image forming apparatus configured as mentioned above and an image output method of the image forming apparatus according to an embodiment of the present general inventive concept includes the media detecting device that acquires the contour form information on the printing medium and correctly measures the format, the skew and the shift quantities of the printing medium based on the contour form information and forms the image at precise position on the printing medium. Accordingly, forming of the image deviated from the printing medium may be prevented even if the format of the printing medium is inappropriate. Also, the image may be formed on the desired position of the printing medium by forming the image on the photosensitive body by compensating as much as the corresponding values of the skew and shift quantities even if the printing medium 30 is skewed and shifted.

Although a few exemplary embodiments of the present general inventive concept have been shown and described, it will be appreciated by those skilled in the art that changes may be made in these embodiments without departing from the principles and spirit of the invention, the scope of which is defined in the appended claims and their equivalents.

What is claimed is:

1. A medium detecting device to detect information corresponding to a printing medium fed through a medium transport path, comprising:
a detecting unit to detect contour form information of the printing medium; and
a discriminating unit to determine a format of the printing medium and feeding information based on the contour form information of the printing medium detected by the detecting unit.

2. The medium detecting device according to claim 1, wherein the feeding information comprises at least one of a magnification, a skew quantity and a shift quantity of the printing medium.

3. The medium detecting device according to claim 1, wherein the detecting unit comprises:
a light source to radiate a light; and
a plurality of light receiving elements arranged larger than a maximum permitted width of the printing medium across in a width direction of printing medium,
wherein the medium detecting device detects a size, a skew quantity and a shift quantity of the fed printing medium by selectively receiving the light radiated from the light source depending on an interference of the printing medium.

4. The medium detecting device according to claim 3, wherein the plurality of light receiving elements have equal sizes and are separated from each other by a constant interval.

5. The medium detecting device according to claim 1, wherein the detecting unit comprises:
a plurality of sensing bars installed on the medium transport path in the width direction of the printing medium to be freely rotated; and
a plurality of sensors to sense respective rotation states of the sensing bars depending on an interference of the printing medium,
wherein the medium detecting device detects a size, a skew quantity and a shift quantity of the fed printing medium by selectively receiving the light radiated from the light source depending on an interference of the printing medium.

6. The medium detecting device according to claim 5, wherein each of the plurality of sensors comprises:
a light emitting element to radiate a light; and
a light receiving element to face the light emitting element leaving each sensing bar of the plurality of sensing bars therebetween and to selectively receive the light radiated from the light emitting element depending on a position of the sensing bar.

7. The medium detecting device according to claim 1, wherein the discriminating unit comprises:
a memory to store information on the format of the printing medium; and
a counter to calculate a transport time between a leading and trailing edges of the printing medium,
wherein the medium detecting device determines the format of the fed printing medium by comparing information on the printing medium detected by the detecting unit and the counter and the information on the format of the printing medium stored in the memory.

8. The medium detecting device according to claim 1, wherein the detecting unit comprises:
a first detecting unit disposed at a first location on the medium transport path along a width direction of the printing medium; and
a second detecting unit disposed at a second location on the medium transport path along the width direction of the printing medium distanced from the first detecting unit.

9. The medium detecting device according to claim 8, wherein the discriminating unit determines a format and a feeding position of the printing medium based on data detected in the first and the second detecting units.

10. The medium detecting device according to claim 8, wherein the discriminating unit comprises:
a memory to store information on the format of the printing medium; and
a counter to calculate a transport time between a leading and trailing edges of the printing medium,
wherein the discriminating unit determines the format of the fed printing medium by comparing information on the printing medium detected by the first detecting unit, the second detecting unit and the counter and the information on the format of the printing medium stored in the memory.

11. A medium detecting method of detecting information on a fed printing medium through a medium transport path, the method comprising:
detecting the contour form information of the fed printing medium; and
discriminating a format and feeding information on the fed printing medium based on the detected contour form information of the fed printing medium.

12. The medium detecting method according to claim 11, wherein the feeding information comprises at least one of a magnification, a skew quantity and a shift quantity of the fed printing medium.

13. The medium detecting method according to claim 11, wherein the detecting of the contour form information of the fed printing medium comprises:
radiating a light;
outputting a signal after receiving the radiated light through a plurality of light receiving elements arranged longer than a maximum permitted width of the printing medium across in a width direction of the fed printing medium in every predetermined time interval dependent on an existence of the fed printing medium; and
recognizing the contour form information of the fed printing medium using the output signal.

14. The medium detecting method according to claim 13, wherein the discriminating comprises
determining the format of the fed printing medium;
determining the skew quantity of the fed printing medium; and
determining the shift quantity of the fed printing medium.

15. The medium detecting method according to claim 14, wherein the determining the format of the fed printing medium comprises:
calculating a width of the fed printing medium with the output signal from the detecting of the fed printing medium contour form information; and
calculating a length of the fed printing medium by an arithmetic operation with a pass time of the fed printing medium at a location of the detecting unit.

16. The medium detecting method according to claim 15, wherein the determining the format of the fed printing medium further comprises:
storing a standard format of a printing medium; and
deciding a format of the fed printing medium format through comparing the stored standard format with the calculated width and length of the fed printing medium.

17. The medium detecting method according to claim 14, wherein the determining the format of the fed printing medium comprises:
determining a feeding direction of the fed printing medium;
calculating a width of the fed printing medium with the output signal from the detecting of the contour form information of the fed printing medium;
storing a standard format of a printing medium; and
deciding a format of the fed printing medium format including a length of the fed printing medium through comparing the standard format of the printing medium with the calculated width of the fed printing medium based on the determining of the feeding direction of the fed printing medium.

18. The medium detecting method according to claim 15, wherein the calculating the width of the fed printing medium with the output signal satisfies a following equation:
P_{width}=sqrt(X²+Y²)
X=(i_{—}cw−i_{—}ccw)×(w+d)+m
Y=f×V×T
where i_cw is an index value of the light receiving element disposed at a location which first meets a corner vertex of the fed printing medium and i_ccw is an index value of the light receiving element disposed at a location which meets an opposite other corner vertex of the fed printing medium, w is the width of the light receiving element, d is the interval between the light receiving elements, m is a margin that compensates to consider when the edge of the fed printing medium covers one light receiving element or the interval, f is a number of counts counted during an entering of the printing medium from the first entering of the corner vertex of the fed printing medium till the last entering of the other corner vertex of the fed printing medium, V is a feeding speed of the fed printing medium, and T is a detecting period of the light receiving element.

19. The medium detecting method according to claim 14, wherein:
the plurality of light receiving elements are separated from their adjacent light receiving elements by a predetermined interval; and
the determining the format of the fed printing medium comprises deciding a corner vertex position of a leading edge of the fed printing medium when the corner vertex of the fed printing medium enters the interval between the adjacent light receiving elements.

20. The medium detecting method according to claim 19, wherein the deciding the corner vertex position comprises:
storing an output pattern transition of the light receiving elements in a lookup table according to the skew quantity;
storing sensing values detected in the light receiving elements in a periodic time interval;
deciding the skew quantity by comparing the sensing values detected by the light receiving elements with the pattern stored in the lookup table;
calculating a first line extended straight from the leading edge of the printing medium and a second line extended straight from one side edge of the printing medium; and
calculating the corner vertex position of the leading edge of the fed printing medium from an intersection point of the first line and the second line.

21. The medium detecting method according to claim 14, wherein the determining the skew quantity of the fed printing medium comprises:
storing a number of counts from a time when the fed printing medium is first detected until two opposite side edges of the fed printing medium are detected;
deciding whether the fed printing medium is skewed according to which light receiving element among the plurality of light receiving elements first detects the fed printing medium;
storing an index value of the light receiving element disposed at a location which first meets a corner vertex of the fed printing medium and an index value of the light receiving element disposed at a location which meets an opposite other corner vertex of the fed printing medium; and
calculating the skew quantity through comparing the number of counts and the stored index values stored.

22. The medium detecting method according to claim 21, the skew quantity satisfies a following equation:
Skew quantity=arctan(Y/X)
X=(i_{—}cw−i_{—}ccw)×(w+d)+m
Y=f×V×T
where i_cw is an index value of the light receiving element disposed at a location which first meets a corner vertex of the fed printing medium and i_ccw is an index value of the light receiving element disposed at a location which meets an opposite other corner vertex of the fed printing medium, w is the width of the light receiving element, d is the interval between the light receiving elements, m is a margin that compensates to consider when the edge of the fed printing medium covers one light receiving element or the interval, f is a number of counts counted during an entering of the printing medium from the first entering of the corner vertex of the fed printing medium till the last entering of the other corner vertex of the fed printing medium, V is a feeding speed of the fed printing medium, and T is a detecting period of the light receiving element.

23. The medium detecting method according to claim 22, wherein the determining the skew quantity of the fed printing medium further comprises:
discerning whether the skew quantity is changed while transporting the fed printing medium; and
calculating the skew quantity at a predetermined target location if the skew quantity changes.

24. The medium detecting method according to claim 23, wherein the discerning of the skew quantity change comprises:
calculating the respective skew quantities of the fed printing medium through a first detecting unit and a second detecting unit which respectively have a plurality of light receiving elements arranged in the width direction of the fed printing medium at a first location and a second location of the medium transport path; and
deciding whether the skew quantity is changed by comparing the skew quantities detected in the first and second detecting units.

25. The medium detecting method according to claim 24, the skew quantity at the target location is calculated by using a following equation:
Δθ₂=Δθ₁×(1+d₂/d₁)
where Δθ₂ is a difference of the skew quantity at the target location from the first location, Δθ₁ is a difference of skew quantity at the second location from the skew quantity at the second location, d₁ is the distance from the first location to the second location, and d₂ is the distance from the second location to the target location.

26. The medium detecting method according to claim 14, wherein the determining of the shift quantity of the fed printing medium comprises:
deciding which light receiving elements among the plurality of the light receiving element located at left and right parts of leading edge of the fed printing medium detect the fed printing medium;
storing the output values from the corresponding light receiving elements respectively located at the left and right top boundary of the fed printing medium in a first index (i_cw) and (i_ccw); and
calculating the shift quantity of the printing medium at a location of the light receiving elements through comparing the stored values in the first index and the second index.

27. The medium detecting method according to claim 26, the shift quantity satisfy a following equation:
shift quantity=[(i_{—}cw+i_{—}ccw)/2−i_{—}cnt]×(w+d)+m
where w is the width of each light receiving element, d is an interval between each light receiving element, m is a margin, i_cnt is an index value at a center; and
if the shift quantity from this equation is negative, the printing medium is shifted to left side, and
if the shift quantity from this equation is positive, the printing medium is shifted to right side.

28. The medium detecting method according to claim 27, wherein the determining the shift quantity of the fed printing medium further comprises:
discerning whether the shift quantity is changed while transporting the printing medium; and
calculating the shift quantity at a predetermined target location if the shift quantity changes.

29. The medium detecting method according to claim 28, wherein the discerning of the shift quantity change comprises:
calculating the respective shift quantities of the fed printing medium through a first detecting unit and a second detecting unit arranged in the width direction of the fed printing medium at a first location and a second location of the medium transport path; and
deciding whether the shift quantity is changed by comparing the shift quantities detected in the first and second detecting units.

30. The medium detecting method according to claim 29, the shift quantity at the target location is calculated by using a following equation:
ΔS₂=ΔS₁×(1+d₂/d₁)
where ΔS₂ is a difference of the shift quantity at the target location from the shift quantity at the first location, ΔS₁ is a difference of the shift quantity at the second location from the shift quantity at the first location, d₁ is the distance from the first location to the second location, and d₂ is the distance from the second location to the target location.

31. An image forming apparatus, comprising:
a medium feed unit to feed a loaded printing medium through a medium transport path;
an image forming unit to form an image on the fed printing medium;
a detecting unit to detect contour form information of the printing medium; and
a medium detecting device equipped with a discriminating unit to determine a format of the printing medium and feeding information based on the contour form information of the printing medium detected by the detecting unit.

32. The image forming apparatus according to claim 31, wherein the feeding information comprises at least one of a magnification, a skew quantity and a shift quantity of the printing medium.

33. The image forming apparatus according to claim 31, wherein the detecting unit comprises:
a light source to radiate a light; and
a plurality of light receiving elements arranged larger than a maximum permitted width of the printing medium across in a width direction of printing medium,
wherein the medium detecting device detects a size, a skew quantity and a shift quantity of the fed printing medium by selectively receiving the light radiated from the light source depending on an interference of the printing medium.

34. The image forming apparatus according to claim 33, wherein the plurality of light receiving elements have equal sizes and are separated from each other by a constant interval.

35. The image forming apparatus according to claim 31, wherein the detecting unit comprises:
a plurality of sensing bars installed on the medium transport path in the width direction of the printing medium to be freely rotated; and
a plurality of sensors to sense respective rotation states of the sensing bars depending on an interference of the printing medium,
wherein the detecting unit detects a size, a skew quantity and a shift quantity of the fed printing medium by selectively receiving the light radiated from the light source depending on an interference of the printing medium.

36. The image forming apparatus according to claim 35, wherein each sensor of the plurality of sensors comprises:
a light emitting element to radiate a light; and
a light receiving element to face the light emitting element leaving each sensing bar of the plurality of sensing bars therebetween and to selectively receive the light radiated from the light emitting element depending on a position of the sensing bar.

37. The image forming apparatus according to claim 31, wherein the discriminating unit comprises:
a memory to store information on the format of the printing medium; and
a counter to calculate a transport time between a leading and trailing edges of the printing medium,
wherein the discriminating unit determines the format of the fed printing medium by comparing information on the printing medium detected by the detecting unit and the counter and the information on the format of the printing medium stored in the memory.

38. The image forming apparatus according to claim 31, wherein the detecting unit comprises:
a first detecting unit disposed at a first location on the medium transport path along the width direction of the printing medium; and
a second detecting unit disposed at a second location on the medium transport path along the width direction of the printing medium distanced from the first detecting unit.

39. The image forming apparatus according to claim 38, wherein the discriminating unit determines the format and a feeding position of the printing medium based on data detected in the first and the second detecting units.

40. The image forming apparatus according to claim 38, wherein the discriminating unit comprises:
a memory to store information on the format of the printing medium; and
a counter to calculate a transport time between a leading and trailing edges of the printing medium, and
wherein the discriminating unit determines the format of the fed printing medium by comparing information on the printing medium detected by the first detecting unit, the second detecting unit and the counter and the information on the format of the printing medium stored in the memory.

41. The image forming apparatus according to claim 31, wherein the image forming unit forms the image on the printing medium fed by an electro-photographic process or an ink-jet head process.

42. The image forming apparatus according to claim 31, further comprising:
an image compensating unit to compensate an image forming error through feedback of the contour form information of the fed printing medium detected by the media detecting device.

43. The image forming apparatus according to claim 31, further comprising:
a user interface unit to inform a user whether the format of the fed printing medium corresponds with a medium format set by a user.

44. An image output method of an image forming apparatus comprising a medium feed unit to feed a loaded printing medium through a medium transport path, an image forming unit to form an image on the fed printing medium, and a medium detecting device provided on a medium transport path to detect information of the fed printing medium, the image output method comprising:
detecting the contour form information of the fed printing medium;
discriminating a format and feeding information on the fed printing medium based on the detected contour form information of the fed printing medium; and
compensating an image forming error through feedback of the detected format and a feeding position of the fed printing medium

45. The image output method of the image forming apparatus according to claim 44, wherein the feeding information comprises at least one of a magnification, a skew quantity and a shift quantity of the fed printing medium.

46. The image output method of the image forming apparatus according to claim 44, wherein the detecting of the contour form information of the fed printing medium comprises:
radiating a light;
outputting a signal after receiving the radiated light through a plurality of light receiving elements which are arranged longer than a maximum permitted width of the printing medium across in a width direction of the fed printing medium in every predetermined time interval dependent on an existence of the fed printing medium; and
recognizing the contour form information of the fed printing medium using the output signal.

47. The image output method of the image forming apparatus according to claim 46, wherein the discriminating comprises
determining the format of the fed printing medium;
determining a skew quantity of the fed printing medium; and
determining a shift quantity of the fed printing medium.

48. The image output method of the image forming apparatus according to claim 47, wherein the determining the format of the fed printing medium comprises:
calculating a width of the fed printing medium with the output signal from the detecting of the fed printing medium contour form information; and
calculating a length of the fed printing medium by an arithmetic operation with a pass time of the fed printing medium at a location of the detecting unit.

49. The image output method of the image forming apparatus according to claim 48, wherein the determining the format of the fed printing medium further comprises:
storing a standard format of a printing medium; and
deciding a format of the fed printing medium format through comparing the stored standard format with the calculated width and length of the fed printing medium.

50. The image output method of the image forming apparatus according to claim 47, wherein the determining the format of the fed printing medium comprises:
determining a feeding direction of the fed printing medium;
calculating a width of the fed printing medium with the output signal from the detecting of the contour form information of the fed printing medium;
storing a standard format of a printing medium; and
deciding a format of the fed printing medium format including a length of the fed printing medium through comparing the standard format of the printing medium with the calculated width of the fed printing medium based on the determining of the feeding direction of the fed printing medium.

51. The image output method of the image forming apparatus according to claim 50, wherein the calculating the width of the fed printing medium with the output signal satisfies a following equation:
P_{width}=sqrt(X²+Y²)
X=(i_{—}cw−i_{—}ccw)×(w+d)+m
Y=f×V×T
where i_cw is an index value of the light receiving element disposed at a location which first meets a corner vertex of the fed printing medium and i_ccw is an index value of the light receiving element disposed at a location which meets an opposite other corner vertex of the fed printing medium, w is the width of the light receiving element, d is the interval between the light receiving elements, m is a margin that compensates to consider when the edge of the fed printing medium covers one light receiving element or the interval, f is a number of counts counted during an entering of the printing medium from the first entering of the corner vertex of the fed printing medium till the last entering of the other corner vertex of fed printing medium, V is a feeding speed of the fed printing medium, and T is a detecting period of the light receiving element.

52. The image output method of the image forming apparatus according to claim 47, wherein:
the plurality of light receiving elements are separated from their adjacent light receiving elements by a predetermined interval; and
the determining the format of the fed printing medium comprises deciding a corner vertex position of a leading edge of the fed printing medium when the corner vertex of the fed printing medium enters the interval between the adjacent light receiving elements.

53. The image output method of the image forming apparatus according to claim 52, wherein the deciding the corner vertex position comprises:
storing an output pattern transition of the light receiving elements in a lookup table according to the skew quantity;
storing sensing values detected in the light receiving elements in a periodic time interval;
deciding the skew quantity by comparing the sensing values detected by the light receiving elements with the pattern stored in the lookup table;
calculating a first line extended straight from the leading edge of the printing medium and a second line extended straight from one side edge of the printing medium; and
calculating the corner vertex position of the leading edge of the fed printing medium from an intersection point of the first line and the second line.

54. The image output method of the image forming apparatus according to claim 47, wherein the determining the skew quantity of the fed printing medium comprises:
storing a number of counts from a time when the fed printing medium is first detected until two opposite side edges of the fed printing medium are detected;
deciding whether the fed printing medium is skewed according to which light receiving element among the plurality of light receiving elements first detects the fed printing medium;
storing an index value of the light receiving element disposed at a location which first meets a corner vertex of the fed printing medium and an index value of the light receiving element disposed at a location which meets an opposite other corner vertex of the fed printing medium; and
calculating the skew quantity through comparing the number of counts and the stored index values stored.

55. The image output method of the image forming apparatus according to claim 54, the skew quantity satisfies a following equation:
Skew quantity=arctan(Y/X)
X=(i_{—}cw−i_{—}ccw)×(w+d)+m
Y=f×V×T
where i_cw is an index value of the light receiving element disposed at a location which first meets a corner vertex of the fed printing medium and i_ccw is an index value of the light receiving element disposed at a location which meets an opposite other corner vertex of the fed printing medium, w is the width of the light receiving element, d is the interval between the light receiving elements, m is a margin that compensates to consider when the edge of the fed printing medium covers one light receiving element or the interval, f is a number of counts counted during an entering of the printing medium from the first entering of the corner vertex of the fed printing medium till the last entering of the other corner vertex of fed printing medium, V is a feeding speed of the fed printing medium, and T is a detecting period of the light receiving element.

56. The image output method of the image forming apparatus according to claim 55, wherein the determining the skew quantity of the fed printing medium further comprises:
discerning whether the skew quantity is changed while transporting the fed printing medium; and
calculating the skew quantity at a predetermined target location if the skew quantity changes.

57. The image output method of the image forming apparatus according to claim 56, wherein the discerning of the skew quantity change comprises:
calculating the respective skew quantities of the fed printing medium through a first detecting unit and a second detecting unit which respectively have a plurality of light receiving elements arranged in the width direction of the fed printing medium at a first location and a second location of the medium transport path; and
deciding whether the skew quantity is changed by comparing the skew quantities detected in the first and second detecting units.

58. The image output method of the image forming apparatus according to claim 57, the skew quantity at the target location is calculated by using a following equation:
Δθ₂=Δθ₁×(1+d₂/d₁)
where Δθ₂ is a difference of the skew quantity at the target location from the first location, Δθ₁ is a difference of skew quantity at the second location from the skew quantity at the second location, d₁ is the distance from the first location to the second location, and d₂ is the distance from the second location to the target location.

59. The image output method of the image forming apparatus according to claim 47, wherein the determining the shift quantity of the fed printing medium comprises:
deciding which light receiving elements among the plurality of the light receiving element located at left and right parts of leading edge of the fed printing medium detect the fed printing medium;
storing the output values from the corresponding light receiving elements respectively located at the left and right top boundary of the fed printing medium in a first index (i_cw) and (i_ccw); and
calculating the shift quantity of the printing medium at a location of the light receiving elements through comparing the stored values in the first index and the second index.

60. The image output method of the image forming apparatus according to claim 59, the shift quantity satisfy a following equation:
shift quantity=[(i_{—}cw+i_{—}ccw)/2−i_{—}cnt]×(w+d)+m
where w is the width of each light receiving element, d is an interval between each light receiving element, m is a margin, i_cnt is an index value at a center; and
if the shift quantity from this equation is negative, the printing medium is shifted to left side, and
if the shift quantity from this equation is positive, the printing medium is shifted to right side.

61. The image output method of the image forming apparatus according to claim 60, wherein the determining the shift quantity of the fed printing medium further comprises:
discerning whether the shift quantity is changed while transporting the printing medium; and
calculating the shift quantity at a predetermined target location if the shift quantity changes.

62. The image output method of the image forming apparatus according to claim 61, wherein the discerning of the shift quantity change comprises:
calculating the respective shift quantities of the fed printing medium through a first detecting unit and a second detecting unit arranged in the width direction of the fed printing medium at a first location and a second location of the medium transport path; and
deciding whether the shift quantity is changed by comparing the shift quantities detected in the first and second detecting units.

63. The image output method of the image forming apparatus according to claim 62, the shift quantity at the target location is calculated by using a following equation:
ΔS₂=ΔS₁×(1+d₂/d₁)
where ΔS₂ is a difference of the shift quantity at the target location from the shift quantity at the first location, ΔS₁ is a difference of the shift quantity at the second location from the shift quantity at the first location, d₁ is the distance from the first location to the second location, and d₂ is the distance from the second location to the target location.

64. The image output method of the image forming apparatus according to claim 44, further comprises:
determining whether the format of the fed printing medium corresponds with a medium format set by a user; and
notifying an incompatibility to a user if the format does not corresponds to the set format.

65. An image forming apparatus, comprising:
an image forming unit to form an image onto a printing medium while being fed into the image forming unit;
a medium detecting device to detect contour form information corresponding to the printing medium; and
an exposure unit to adjust an image signal based on the detected contour form information to print the image onto the printing medium without the image being skewed or shifted on the printing medium.

66. The image forming apparatus of claim 65, wherein the exposure unit adjusts the image signal in response to at least one of a size, a skew quantity and a shift quantity of the printing medium.

67. The image forming apparatus of claim 66, further comprising:
a plurality of light receiving elements to receive light from a light source depending on an interference of the printing medium.

68. The image forming apparatus of claim 67, wherein the exposure unit adjusts the image signal based on the light received by the plurality of light receiving elements.

69. An image forming method, comprising:
feeding a printing medium into an image forming unit;
detecting contour form information corresponding to the printing medium; and
adjusting an image signal based on the detected contour form information to print an image onto the printing medium without the image being skewed or shifted on the printing medium.

70. The method of claim 69, wherein the adjusting of the image signal occurs in response to at least one of a size, a skew quantity and a shift quantity of the printing medium.

71. The method of claim 70, further comprising:
receiving light from a light source depending on an interference of the printing medium.

72. The method of claim 71, wherein the adjusting of the image signal is based on the received light.
